(19) United States
(12) Patent Application Publication
(10) Pub. No.: US 2020/0320622 A1
(43) Pub. Date: Oct. 8, 2020

(54) METHOD AND SYSTEM FOR PROCESSING AND DOCUMENTING DIGITAL TRANSACTIONS

(71) Applicant: Secude AG, Lucerne (CH)

(72) Inventors: Philipp Meier, Lucerne (CH); David Reber, Lucerne (CH); Heiner Kromer, Emmetten (CH)

(21) Appl. No.: 16/839,778

(22) Filed: Apr. 3, 2020

Related U.S. Application Data
(63) Continuation-in-part of application No. 16/717,512, filed on Dec. 17, 2019.
(60) Provisional application No. 62/829,880, filed on Apr. 5, 2019.
(60) Provisional application No. 62/860,373, filed on Jun. 12, 2019.

(51) Int. Cl. G06Q 40/04; H04L 9/32; G06Q 20/40; G06Q 30/06; G06F 11/34

(52) U.S. Cl. CPC G06Q 40/04; H04L 9/3247; H04L 9/3263; H04L 2209/56; G06Q 30/0635; G06F 11/3476; G06Q 20/4014

(57) ABSTRACT

The present invention relates to a method and system for performing and documenting transactions implemented via a trading platform where transaction details are stored in a secure log and may be authenticated.

### CROSS-REFERENCE TO RELATED APPLICATIONS

The present application is a continuation-in-part of U.S. patent application Ser. No. 16/717,512 filed Dec. 17, 2019 entitled METHOD AND SYSTEM FOR CREATING AND UPDATING AN AUTHENTIC LOG FILE FOR A COMPUTER SYSTEM AND METHOD AND SYSTEM FOR SECURING AND PROCESSING DIGITAL ASSET TRANSACTION and claims benefit of and priority to U.S. Patent Application Provisional Patent Application No. 62/829,880 filed Apr. 5, 2019 entitled METHOD AND SYSTEM FOR CREATING AND UPDATING AN AUTHENTIC LOG FILE FOR A COMPUTER SYSTEM AND METHOD AND SYSTEM FOR SECURING AND PROCESSING DIGITAL ASSET TRANSACTIONS and U.S. Provisional Patent Application No. 62/860,373 filed Jun. 12, 2019 entitled METHOD AND SYSTEM FOR CREATING AND UPDATING AN AUTHENTIC LOG FILE FOR A COMPUTER SYSTEM AND METHOD AND SYSTEM FOR SECURING AND PROCESSING DIGITAL ASSET TRANSACTIONS, the entire content of each of which is hereby incorporated by reference herein.

### BACKGROUND

### Field of the Disclosure

The present disclosure relates to processing and securely documenting digital transactions. More particularly, the present disclosure relates to a system and method for conducting transactions using a trading platform that authenticates purchase orders and acceptances and provides a secure log of all transaction details.

### Related Art

In a computer system, transactions may be recorded in a log file or similar data storage medium, like a database, for example. Conventional transaction records may be provided in a distributed log such as a blockchain which while secure and immutable provides for relatively slow processing and is open to public inspection such that security may be compromised.

Accordingly, it would be desirable to provide a method and/or system of processing and securely storing transaction information that avoids these and other problems.

### SUMMARY

It is an object of the present disclosure to provide an efficient method and/or system to create a secure log regarding transactions processed by computer system in which the authenticity of data in each log entry may be confirmed.

Another object of the present disclosure is to provide a system and method to secure and process transactions and records related thereto that avoid the shortcomings of current technology.

A method for processing and documenting a digital transaction in accordance with an embodiment of the present disclosure includes: (a) receiving, at the trading platform computer system, identification information from at least a first user device associated with a first user; (b) identifying, by the trading platform, the first user based on the identification information;(c) receiving, by the trading platform, purchase order information from the first user device including a digital signature based on a first user certificate associated with the first user; (d) sending, by the trading platform to at least one second user device associated with a second user, the purchase order including a purchase identification number associated with the purchased order; (e) receiving, by the trading platform, a confirmation of the purchase order from the second user device, the confirmation including a second digital signature based on the certificate associated with the second user; (f) generating, by the trading platform, a second confirmation message indicating acceptance of the purchase order by the second user including the signatures of the first user and the second user; (g) sending, by the trading platform to at least the first user device and the second user device, the second confirmation message; (h) generating, by the trading platform, a report including the purchase order, the confirmation message, the purchase identification number and the signatures of the first user and the second user; and (i) recording, by the trading platform, the report in a secure log.

In embodiments, the identification information may include user credential associated with the first user.

In embodiments, the identification information may include a username and a password associated with the first user.

In embodiments, the identifying step may include a step of accessing, by the trading platform computer system, user information associated with a plurality of validated users and comparing the identification information to the user information to identify the first user.

In embodiments, the purchase order information may include product information, quantity information and price information.

In embodiments, the receiving step (c) may include a step of validating the digital signature of the first user.

In embodiments, the receiving step (c) may include a step of: (j) determining whether the purchase order complies with limitations associated with the first user; and in the case where the purchase order does not comply, sending a request for authorization to at least one associated user.

In embodiments, the method may include receiving a second purchase order signed by the at least one associated user using a certificate associated with the at least one associated user.

In embodiments, the sending step (d) may include generating a purchase identification number uniquely associated with the purchase order and adding it to the purchase order sent to the second user.

In embodiments, the purchase identification number may be based on the type of product associated with the product information.

In embodiments, the purchase identification number may be used as a seed to provide a tuple to be stored in the secure log operatively connected to the trading platform computer system.

In embodiments, the method may include: (j) sending, by the trading platform computer system, the purchase order to a third user device associated with a third user, where the third user is a trusted entity with authority to release funds; and (k) receiving, by the trading platform from the third user device, a funds confirmation message including a signature of the third user based on the certificate of the third user confirming there are sufficient funds to complete the purchase.

In embodiments, the sending step (j) and the receiving step (k) are performed before step (e).

In embodiments, the method may include: (j) receiving, by the trading platform computer system, a purchase confirmation signed by the first user and confirming receipt of the product.

In embodiments, the method may include: (k) receiving, by the trading platform, a seller confirmation signed by the second user confirming receipt of the price of the product.

In embodiments, the method may include: (l) storing, by the trading platform, the purchase confirmation and the seller confirmation in the secure log.

In embodiments, the method may include: (j) sending, by the trading platform, the report to a regulatory authority.

In embodiments, the recording step may include generating, by the trading platform computer system, a tuple based on the report, where a purchase identification number is used as a seed to generate the seed and the additional information is used as a second part of the tuple; and storing the tuple in the secure log.

In embodiments, the secure log may be a computer log associated with the trading platform computer system and may include log information associated with each event associated with the trading platform computer system.

In embodiments, the method may include: (j) generating, by the trading platform computer system, an agreement document indicative of a transaction associated with the purchase order; (k) sending, by the trading platform computer system to at least the first user device and the second user device, the agreement document; (l) receiving, by the trading platform, the agreement document including the first user signature and the second user signature; and (m) storing, by the trading platform computer system, the agreement document in the secure log.

In embodiments, the method may include transmitting the report to a regulatory authority.

### BRIEF DESCRIPTION OF THE DRAWINGS

Exemplary embodiments of the present invention will be described with references to the accompanying figures, wherein:

FIG. 1 illustrates an exemplary embodiment of encoding element and log entry suitable for use in a log entry system in accordance with an embodiment of the present disclosure;

FIG. 2 illustrates an exemplary block diagram showing combining of log data with seeds to be provided to an encoding element as part of a log entry system in accordance with an embodiment of the present disclosure;

FIG. 3A illustrates an exemplary block diagram illustrating extraction of log entries from a computer log using a log reporting system in accordance with an embodiment of the present disclosure;

FIG. 3B illustrates an exemplary entry of a computer log created by the log entry system in accordance with an embodiment of the present disclosure;

FIG. 4A illustrates an exemplary block diagram of the multiple processors that may be used to create or authenticate log entries in accordance with an embodiment of the present disclosure;

FIG. 4B illustrates an exemplary computer log including multiple entries provided by the multiple processors of FIG. 4A in accordance with an embodiment of the present disclosure;

FIG. 5A-1 illustrates a detailed view of the log entry system in accordance with an embodiment of the present disclosure in which the encoding element is included is integrated into the log entry device computer system;

FIG. 5A-2 illustrates a detailed view of the log entry system in accordance with another embodiment of the present disclosure in which the encoding element is provided outside of but operably connected to the log entry device computer system;

FIG. 5B-1 illustrates a more detailed view of the log entry system of FIG. 5A-1 in accordance with another embodiment of the present disclosure;

FIG. 5B-2 illustrates a detailed view of the log entry system of FIG. 5A-2 in accordance with another embodiment of the present disclosure;

FIG. 5C-1 illustrates a detailed view of the log entry system of 5A-1 in accordance with another embodiment of the present disclosure;

FIG. 5C-2 illustrates a detailed view of an encryption element of the log entry system used in the system of FIG. 5A-2 in accordance with another embodiment of the present disclosure;

FIG. 5D-1 illustrates a detailed view of the log entry system of FIG. 5A-1 in accordance with another embodiment of the present disclosure;

FIG. 5D-2 illustrates a detailed view of the log entry system of FIG. 5A-2 in accordance with another embodiment of the present disclosure;

FIG. 6 illustrates a flowchart of an exemplary method of generating a computer log in accordance with an embodiment of the present disclosure;

FIG. 7A-1 illustrates a block diagram illustrating interaction between the log entry system and a log reporting system in accordance with an embodiment of the present disclosure;

FIG. 7A-2 is a schematic of a tuple recorded in the computer log using the log entry system and extracted from the computer log using the log reporting system in accordance with an embodiment of the present disclosure;

FIG. 7B illustrates a detailed view of a log reporting system in accordance with an embodiment of the present disclosure;

FIG. 7C illustrates a more detailed view of a log reporting system in accordance with an embodiment of the present disclosure;

FIG. 8 illustrates an exemplary flow chart illustrating a method of authenticating a log entry in accordance with an embodiment of the present disclosure;

FIG. 9A illustrates a detailed view of the interaction between the log entry system of FIG. 5A-2 and the log reporting system in accordance with an embodiment of the present disclosure;

FIG. 9B illustrates a detailed view of the interaction between the log entry system of FIG. 5A-1 and the log reporting system in accordance with an embodiment of the present disclosure;

FIG. 9C illustrates a detailed view of interaction between the log entry system of FIG. 5A-1 and memory elements in accordance with an embodiment of the present disclosure;

FIG. 9D illustrates a detailed view of interaction between the log entry system of FIG. 5A-2 in accordance with an embodiment of the present disclosure;

FIG. 10 illustrates an exemplary block diagram of a trading platform in accordance with an embodiment of the present disclosure; and

FIGS. 11A and 11B illustrate an exemplary flow chart illustrating a method of conducting a transaction using a trading platform in accordance with an embodiment of the present disclosure.

### DETAILED DESCRIPTION OF THE EMBODIMENTS

In some applications, authenticity and integrity of data in a computer log or other record may be protected using a digital signature that is based on the underlying log data. Providing a log file, or other record structure, however, is an active process that continually appends data entries. Current digital signature type systems allow a user to authenticate the complete content of the current state of the log or record, but requires the complete data of the log file, even if a user simply wants to prove or authenticate one entry in the log file. Thus, there is a technical problem inherent in these conventional systems in that they do not allow for securing and authenticating individual record entries. This problem has become more of an issue since it is common to outsource computing tasks to cloud providers which may leave customers unaware of changes that these third parties may have made. This lack of security and transparency with respect to records is a serious problem in the context of audits and regulation.

Another conventional option used to ensure accuracy and integrity is a blockchain. In such an embodiment, every entry added to a log file may be added to a blockchain, which is a distributed ledger maintained on a peer to peer network. Using this approach, however, each user of the peer to peer network has the complete blockchain and original data to authenticate each entry. Furthermore, since the blockchain is a peer to peer operation, transactions posted on the blockchain are visible to others, thus presenting a possible issue with respect to security. In addition, use of a blockchain requires multiple users storing the entire blockchain as well as miners that are used for authentication such that the complete blockchain and all data recorded therein is present on multiple computing systems, which raises an increased risk of security breaches and increases costs as well as processing time. Thus, conventional blockchain record systems suffer from inherent technical problems in that all participants are provided access to the entire record which eliminates confidentiality as well as fact that the blockchain inherently raises both use costs and processing time as the record grows.

As a subset of the blockchain approach, a Merkle tree may be used to construct a log file that allows for authentication of data. The Merkle tree, however, also has limitations with respect to deletions of entries that depend on each other, performance issues and the requirement of controlling ordering while appending entries. Thus, there is an inherent technical problem with Merkle tree systems in that they similarly don't allow for authentication of individual entries in the record.

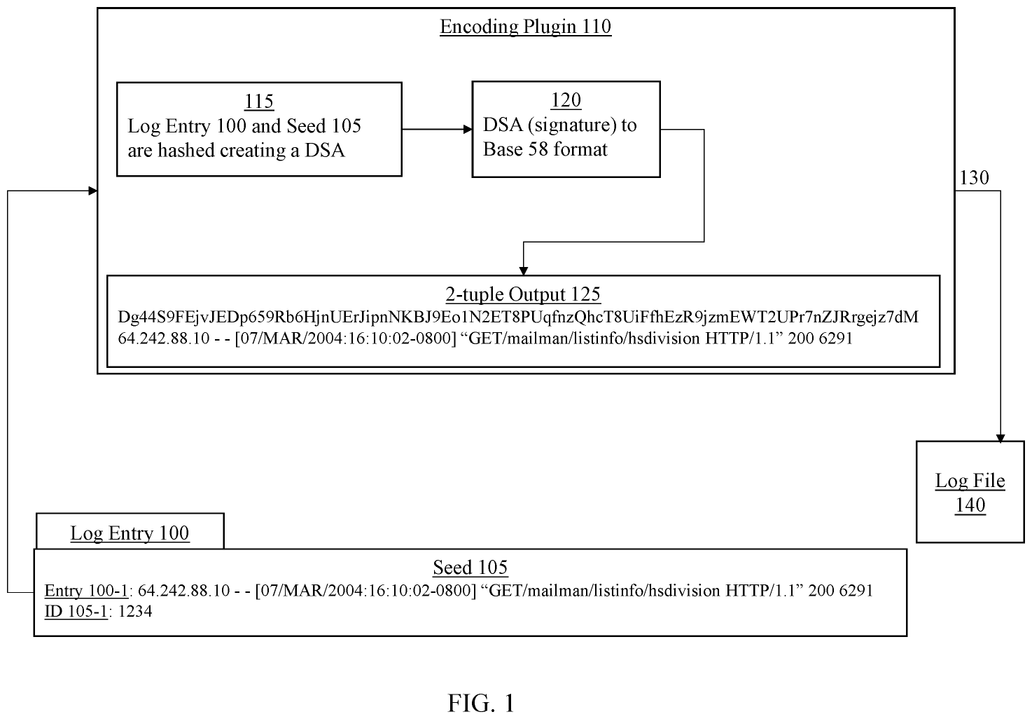

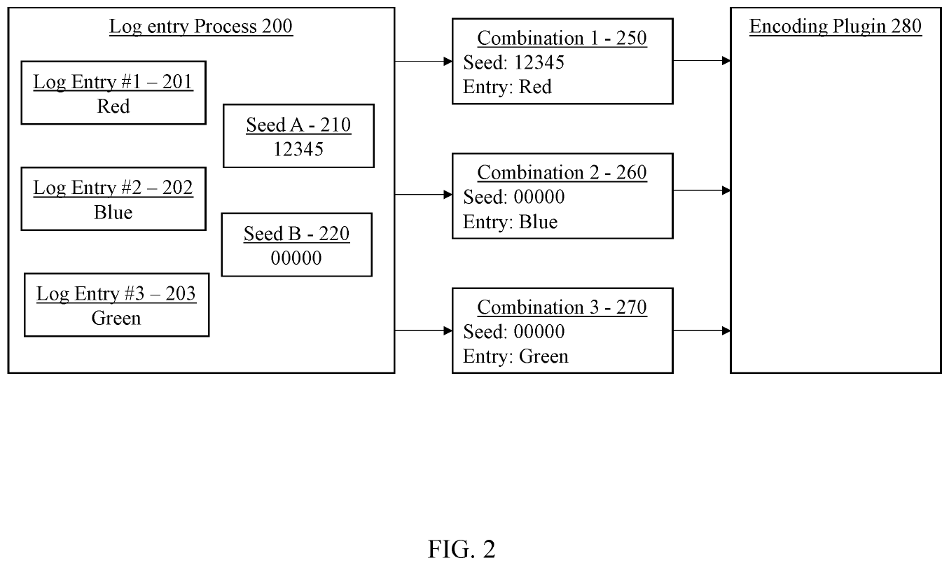

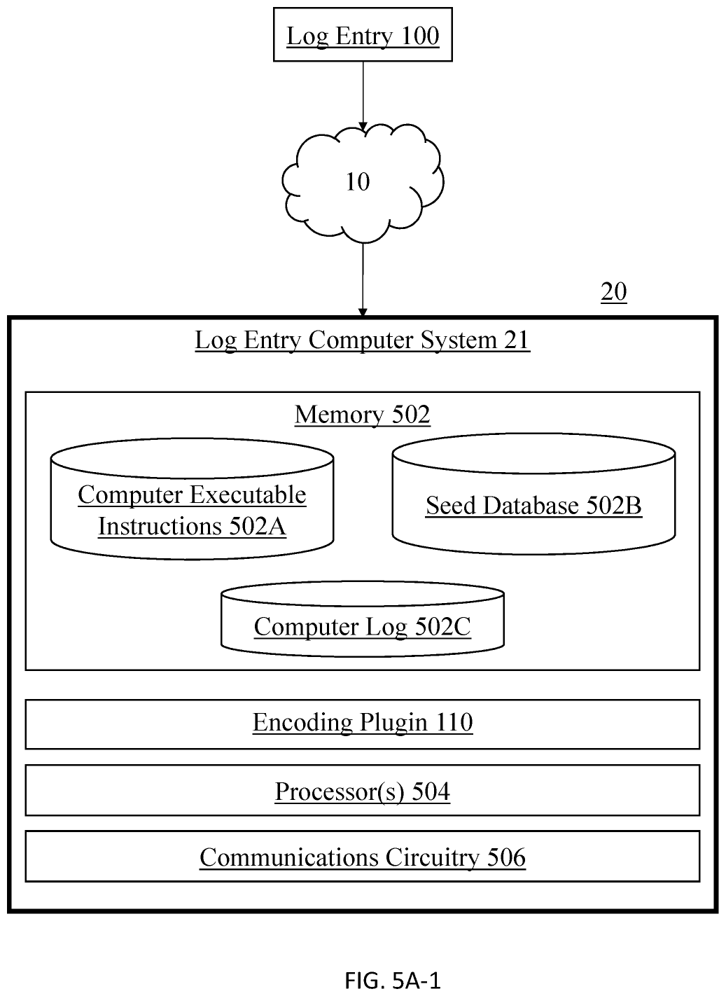

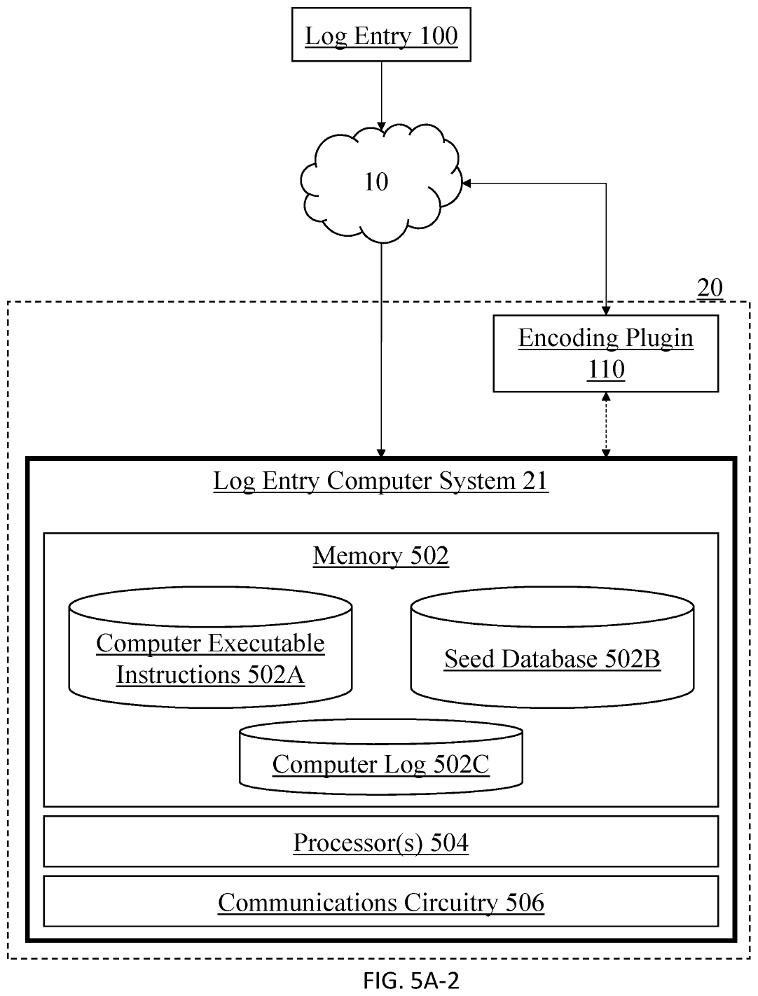

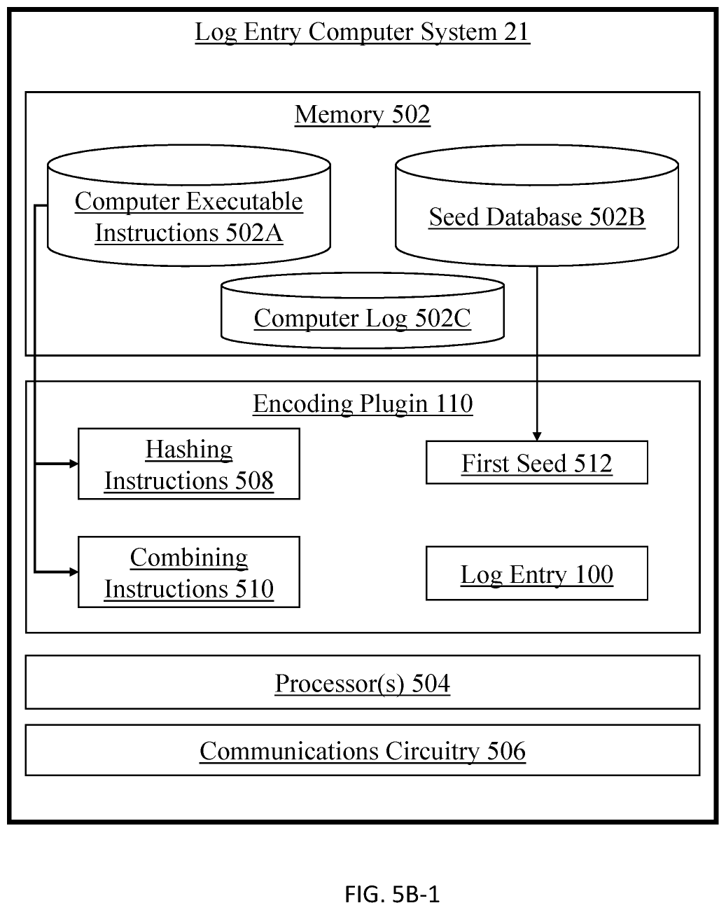

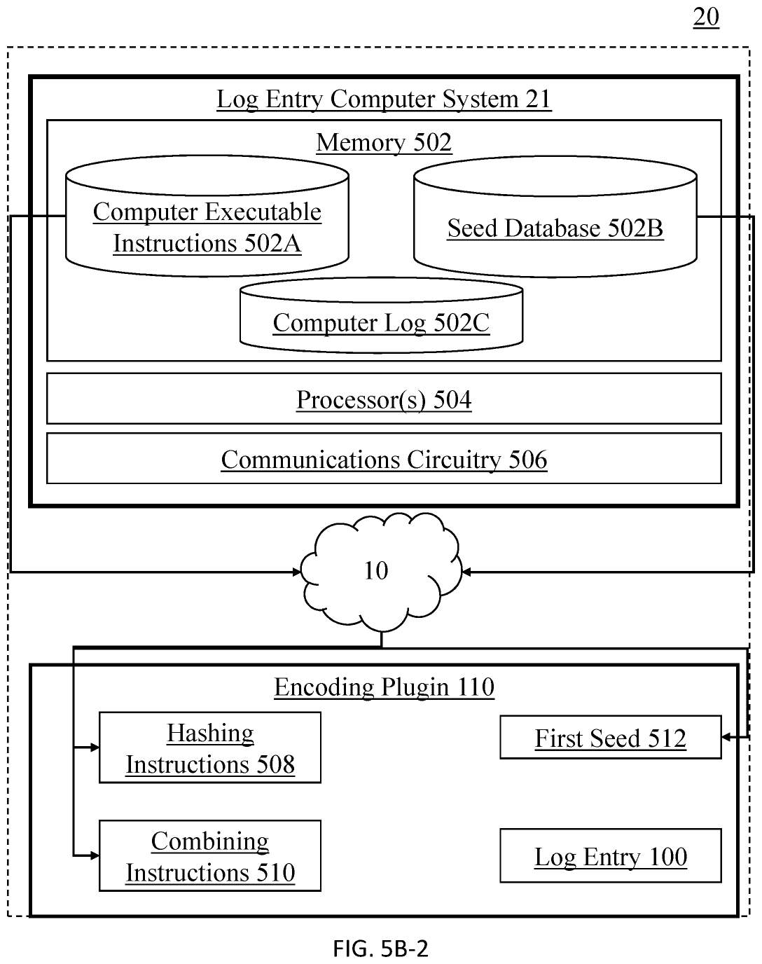

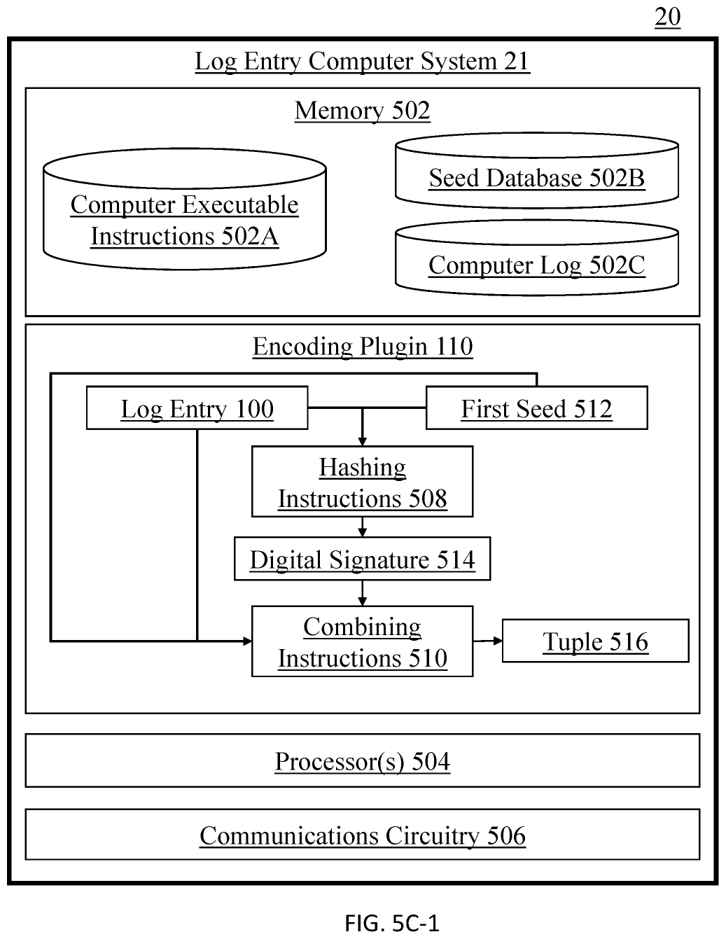

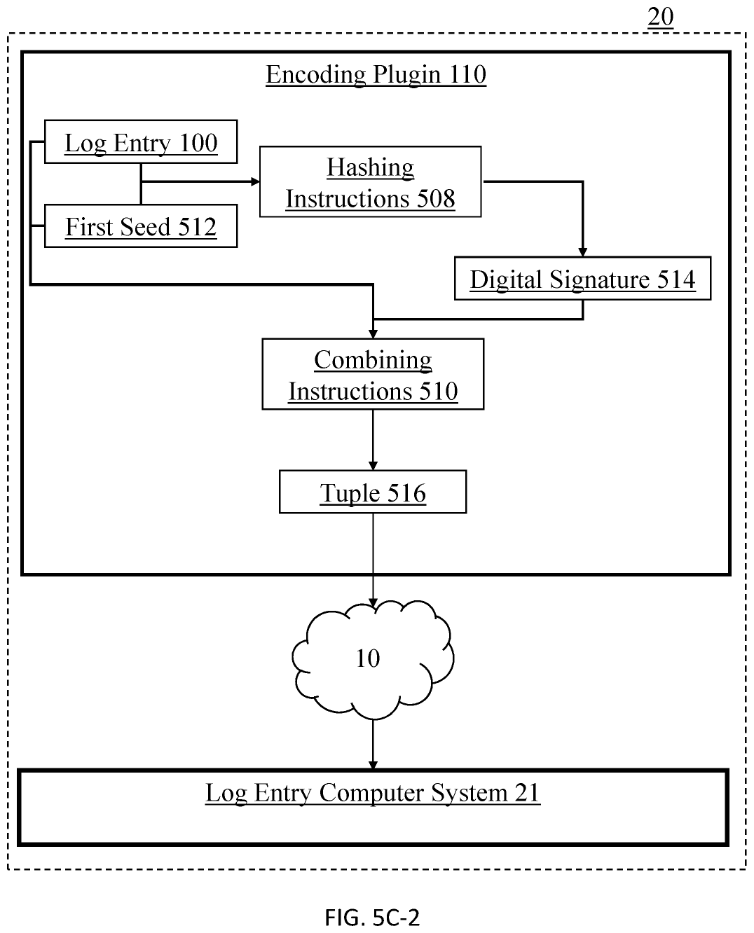

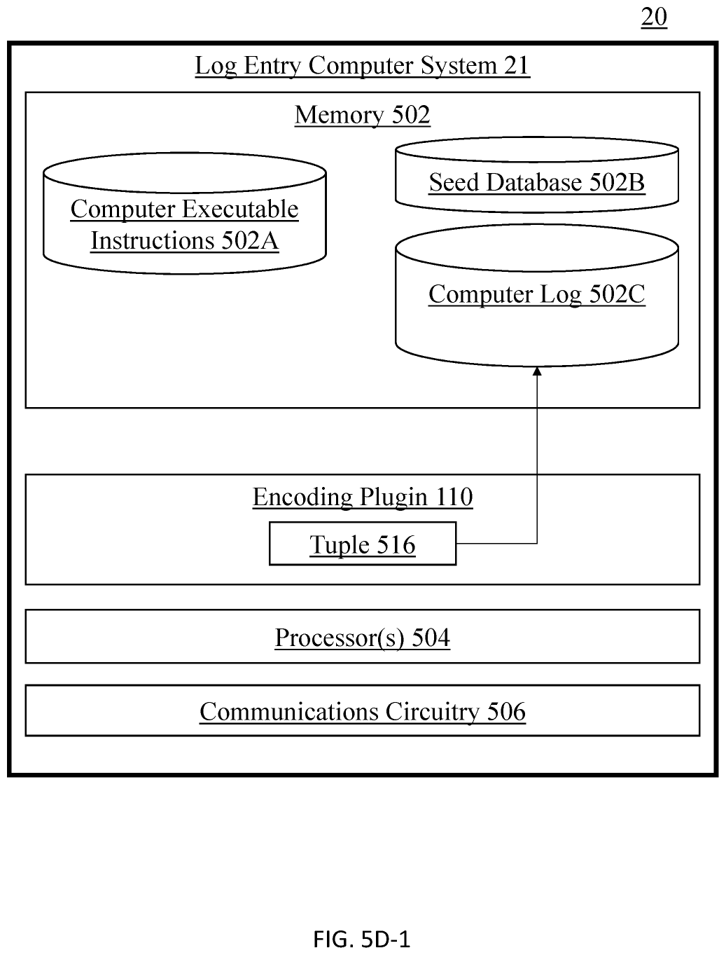

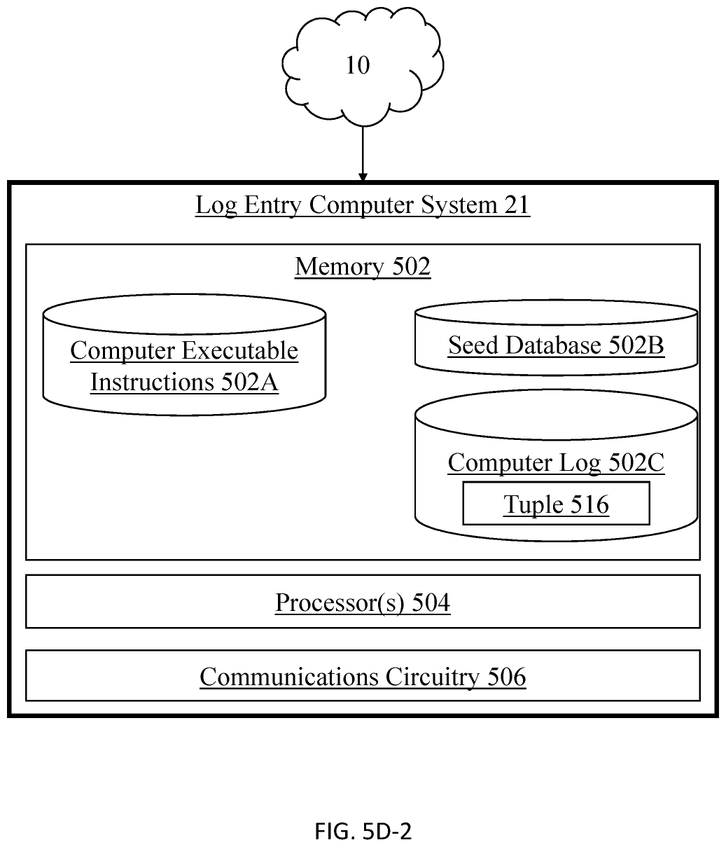

In embodiments, referring to FIG. 1, for example, a log entry or log data 100 is shown that is to be written to a log file 140 using the system and method of the present application. In embodiments, the log entry data and a seed 105, together referenced as 115, may be sent processed by an encoding element or plug-in 110 that is part of or connected to a log entry computer system 21 (see FIG. 5A-1, for example). In embodiments, the encoding element (or plug-in) 110 may operatively be connected to the log entry computer system 21 as part of the log entry system 20 (See FIG. 5A-2). In accordance with an embodiment of the present disclosure, the encoding element or plug-in 110 may hash the seed and log entry data as indicated at 115. In embodiments, the hash may be based on the Secure Hash Algorithm-256 (SHA-256) or any suitable strong hashing method. In embodiments, hashing instructions consistent with the selected hashing algorithm may be provided or stored in the encoding element 110, or in the log entry computer system 21. In embodiments, combining instructions 510 may be provided in the encoding element 110, or in the log entry computer system 21 and executed to combine hashed portion of the tuple with the log data (log entry 100). In embodiments, the seed and the log data may be string copied together and the resulting string may then be hashed. In embodiments, a special symbol may be positioned between the seed and the log data. In embodiments, the seed and log data may be combined in a binary form with the entire result hashed. In embodiments, the seed and the log data may be hashed separately and then copied together. The combined hashed seed and log data may then be signed. In embodiments, a special symbol may separate the seed and the log data. In embodiments, the combined hashed seed and log data may be hashed again and then signed. In embodiments, the hashed seed and data entry may be signed with a digital signature 514 (see FIG. 5C-1, for example) which may be provided or generated in the encoding element 110 or the computer 21 based on a private key which corresponds to a public key. The digital signature may be converted to a readable format, such as Base58, for example, as indicated at 120. In embodiments, the digital signature may be converted to another readable format. In embodiments, the digital signature may not be converted for readability. In embodiments, the digital signature may be paired with the log entry data in the “tuple” as indicated at 125. As used herein, the term “tuple” refers to a pairing of a digital signature including hashed information with a log entry. In embodiments, the tuple may then be written into the log file 140. While the term log file is used, it is noted that the log file 140 is not limited to a file but may be any memory element that stores log entries. This may be done via the encoding element or plug-in 110, the log entry computer system 21 or via another computer system operatively connected thereto.

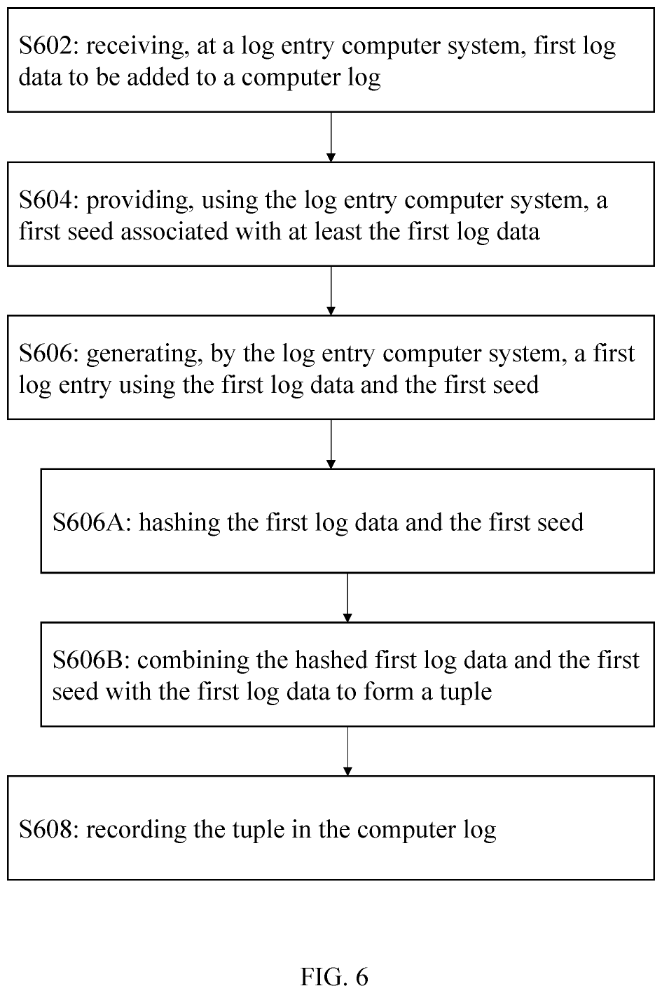

In embodiments, the log entry system 20 may include the log entry computer system 21. In embodiments, the log entry computer system 21 may include the encoding device or plug-in 110 as in FIG. 5A-1. In embodiments, the encoding device 110 may be operably connected to the log entry computer system 101 as in FIG. 5A-2. The log entry system 20 may also include one or more memory elements or databases. In embodiments, an instruction database 502A may include executable instructions that maybe executed by one or more processors 504 of the computer system 21 to execute steps the create and update the computer log 140. In embodiments, these instructions may result in the processor executing the steps of FIG. 6, for example. A seed database 502B may be provided and include a plurality of seed for use in creating log entries. In embodiments, the computer log 140 may be stored in a computer log database 502C. In embodiments, the computer log 140 may be stored in an external memory or database operably connected to the computer 21. In embodiments, log data for a log entry 100 may be provided via a communications network or bus 10 from one or more systems or applications operably connected to the log entry computer system 21. In embodiments, the computer 21 may include communications circuitry 506 to allow for communication via the network or bus 10 or any other suitable communication system.

Referring to FIG. 2, the log entries write log entries to a log file is shown. In embodiments, the log entry system 20 may be implemented in or with an encoding element (or plug-in) 110 as discussed above. In embodiments, computer executable instructions may be provided in memory 502A to the one or more processors 504, that when executed by the processors perform the functions of the log entry system 20 and/or the encoding element 110. In embodiments, three log entries: text “red” 201, text “blue” 202, and text “green” 203 are illustrated. In embodiments, the log entry computer system 21 included in the log entry system 20 may create two unique seeds 210 and 220. In embodiments, the log entry computer system 21 may send the seed 210 with the entry log data text “red” 201 (as indicated by 250) to an encoding element 110 (which may be implemented by the encoding plug-in) to provide an entry in the log based on the log data and seed. In embodiments, the encoding element 110 may be included in the log entry computer system 21. In embodiments, the encoding element may be operatively connected to the log entry computer system 21. In embodiments, the log entry computer system 21 may send the seed 220 with the entry log data text “blue” 202 (as indicated by 260) to the encoding element 110 to write another entry for that log data. The log entry computer system 21 may send the seed 220 with the entry log data, the text “green” 203 (as indicated by 270) to the encoding element 110 to provide an entry for that data. That is, in embodiments, the seed discussed above with respect to FIG. 1 may be provided by the log entry computer system 21 for use by the encoding element 110. In embodiments, the seed may be used to create a relationship between elements in the tuple. In embodiments, a party who has the seed, or access to the seed, may use it to confirm the relationship between the data in the tuples by rehashing the log data with the seed. If the result is the same as included in the tuple, then the elements are properly matched and there has been no manipulation of the tuple. Similarly, log entries or tuples that use the same seed for creation may be related to each other.

FIG. 6 illustrates an exemplary flow chart illustrating a method for entering a log entry into a computer log. In embodiments, at step S602, the log entry computer system 21 obtains first log entry data. The first log entry data may be indicative of an event or occurrent in the log entry computer 21 or may be received from another computer system or another application. At step S604, in embodiments, a first seed is provided. In embodiments, step S604 may come before step S602. In embodiments, the first seed may be selected or generated by the log entry computer system 21. In embodiments, the first seed may be obtained from a storage element include in or operatively connected to the log entry computer system 21. In embodiments, the first seed may be selected based on the content of source of the first log information. In embodiments, in step S606, the log entry computer system 20 generates a first log entry based on the first log entry and the first seed. In particular, in embodiments, the first log data and the first seed may be hashed in step S606A and the result combined to the first log data and digitally signed in step S606B. The resulting tuple including the two parts is then recorded in a computer log in step S608. In embodiments, step S606 may be performed by encoding member 110 which may be integrated into the computer system 21 or separate and operatively connected thereto. In embodiments, the tuple may be signed with an electronic signature based on a private key.

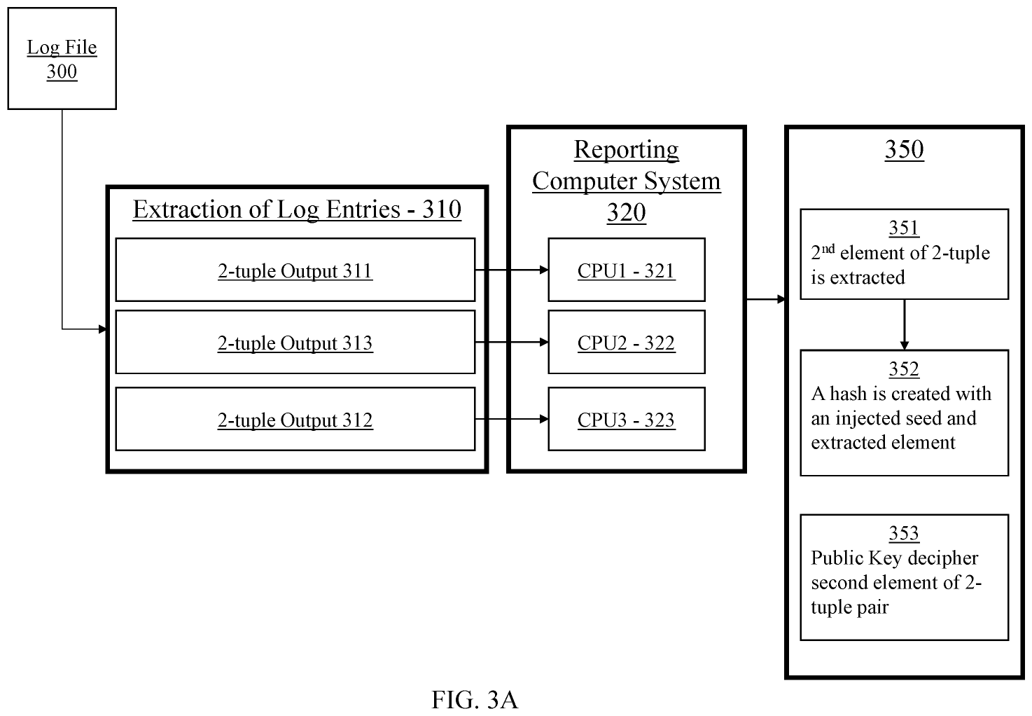

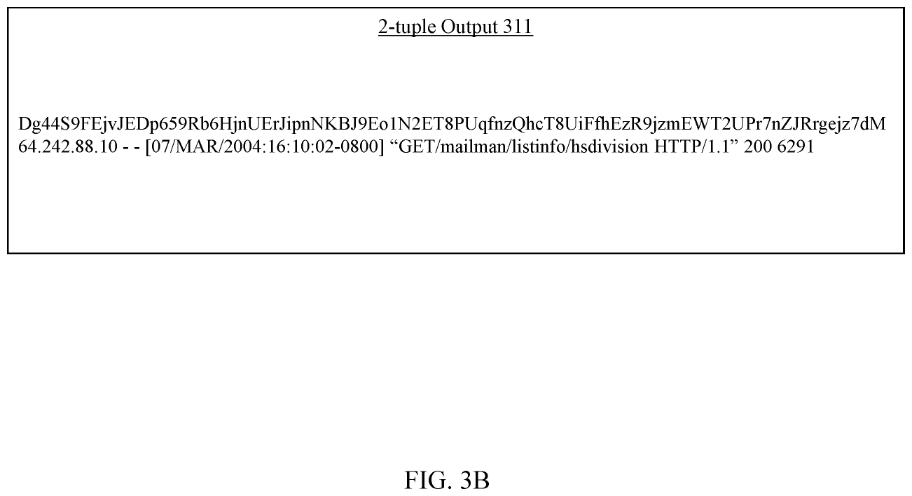

FIG. 3 illustrates exemplary extraction of log entries from a computer log 140. As illustrated, the log entries 311, 312, 313 in a log file 300 are provided as tuples. The log file 300 may be the computer log 140 or another computer log. In embodiments, one or more log entries may be extracted from the log file and authenticated. In embodiments, the three log entries 311, 312, and 313 may be extracted from the log file 300 for authentication. In embodiments, such extraction may be performed by or at the direction of a reporting application implemented on the log entry computer system 21 or a reporting computer system 320. In embodiments, the reporting computer system 320 may be provided with or separate from the log entry computer system 21. In embodiments, extractions of log entries may be based on a context of each entry, such as a date or IP address for filtering entries of interest. In embodiments, each log entry may be formatted as a tuple as noted above. In embodiments, authenticating the log entries may use parallel processing. In embodiments, each log entry may be sent to a different processing unit 321, 322, 323 of the reporting computer system 320 to provide for parallel processing to authenticate each log entry. In embodiments, a cluster of computers may be used to implement the reporting computer system 320 which may include the processing units 321, 322, 323, as well as others, if desired. In embodiments, rather than a cluster of computers, a multi-core processor may be used.

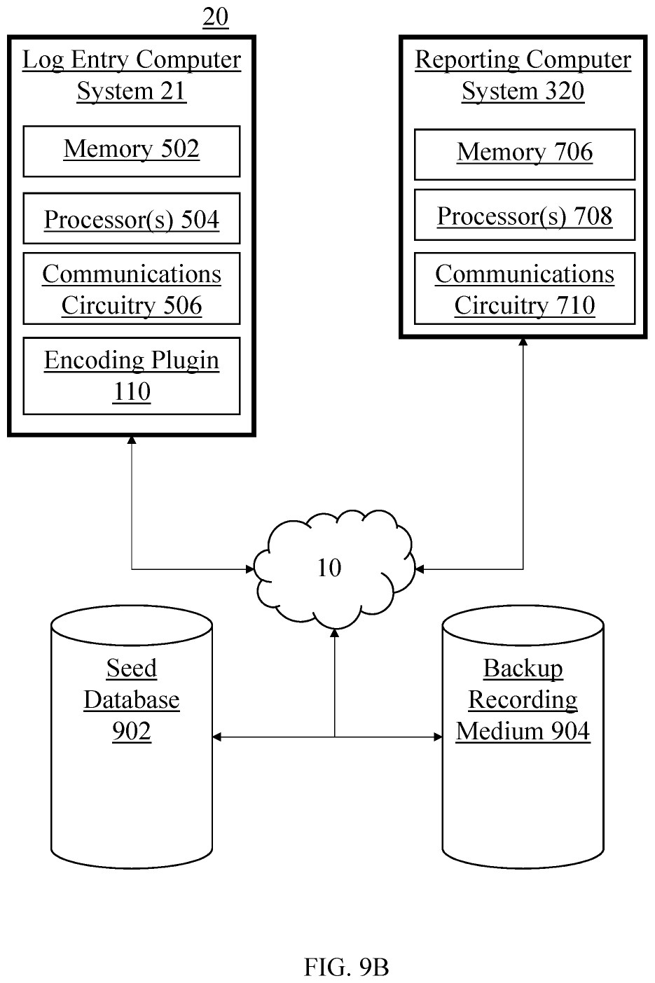

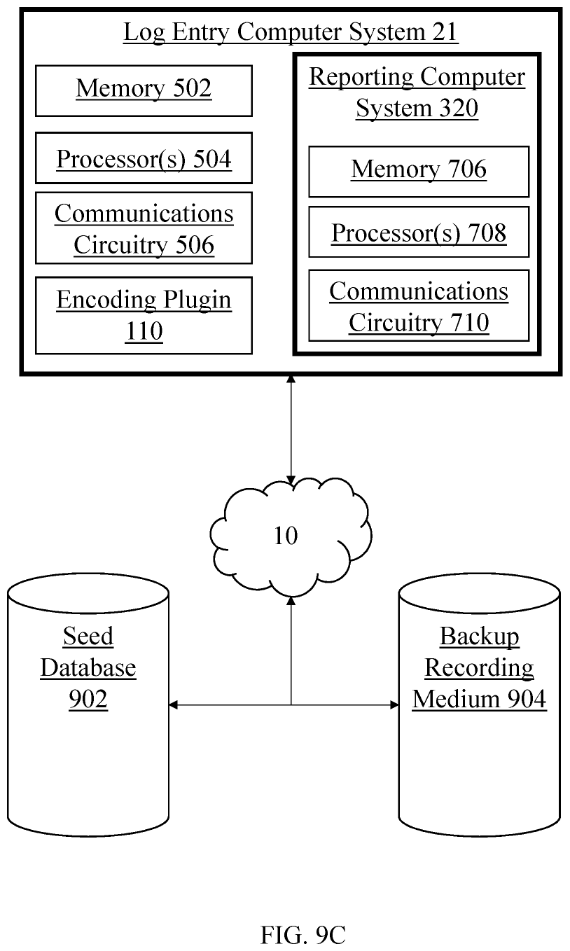

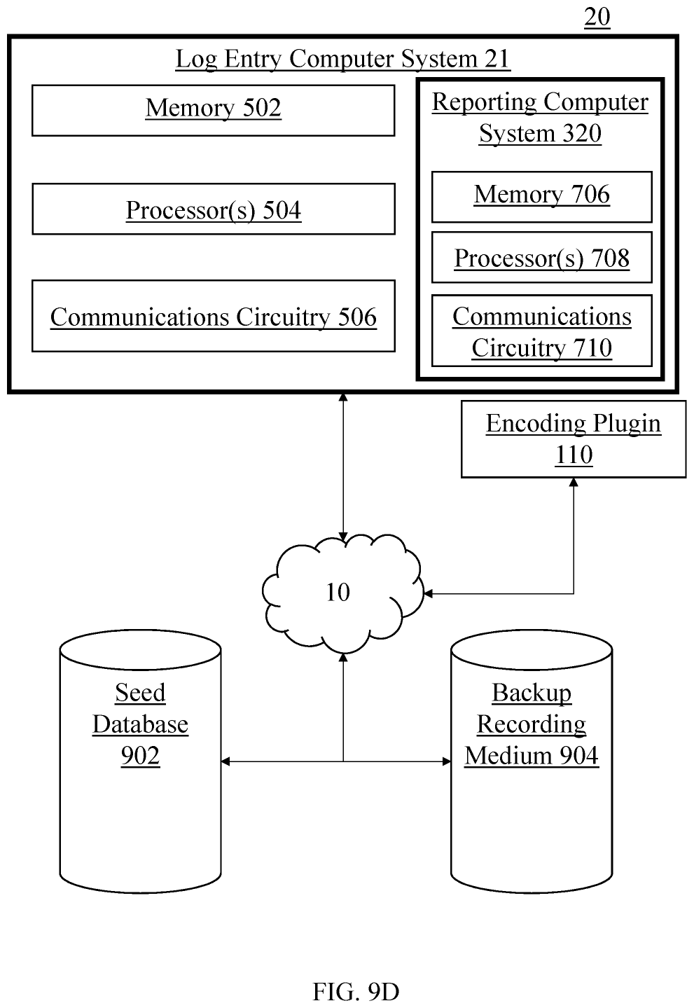

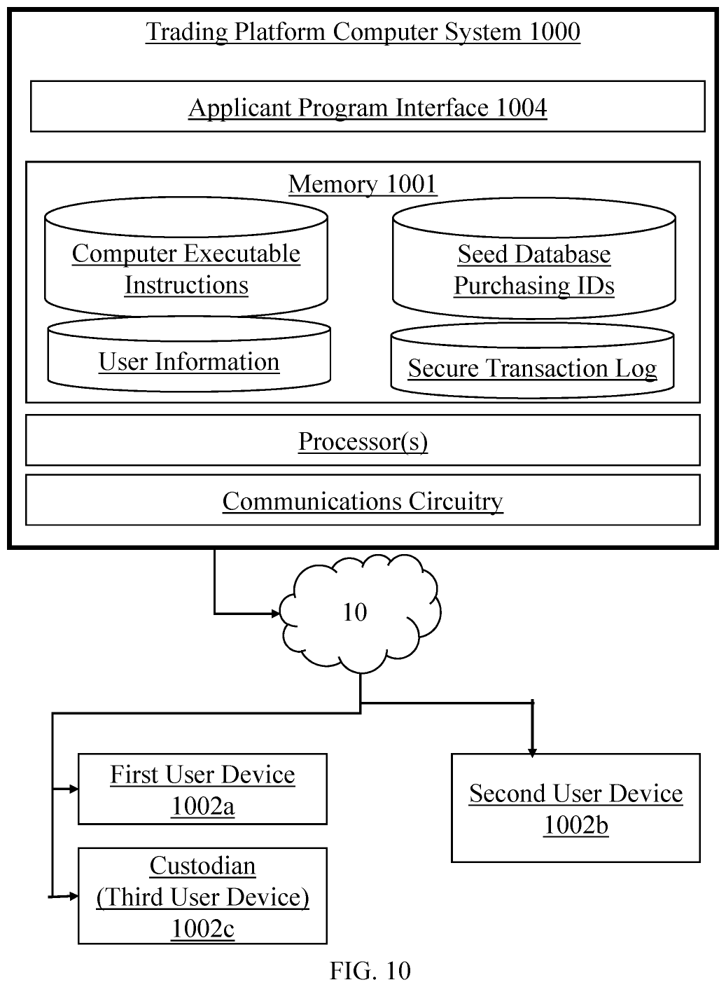

In embodiments, the log entry 311 may be processed for nonrepudiation (authenticity) using processor 321. In particular, as indicated at 350, each processor 321, 322, 323 may extract the second element of the tuple that makes up each log entry and a Hash 352 may be created with an injected seed. In embodiments, this seed may be obtained from a database based on criteria of the log entry data or may be included with the tuple that is extracted. In embodiments, the seed may be used as a system identifier, that is, identifying the system that made the log entry. In embodiments, the seed may be used as a user identifier associate with a user of the system that made the log entry. In embodiments, the seed may be used to establish other relationships between tuples in the computer log and certain environments. In embodiments, the seed may be related to business process ideas. In embodiments, the seed may be retrieved from one or more databases such as database 502B discussed above or the seed database 902 illustrated in FIG. 9A for example. In embodiments the seed may be obtained from an external storage system or another secure storage system. In embodiments, hashing may be used to show that the first element of the tuple, including the digital signature, was derived from the second element of the tuple (the log data) for proof of the authenticity of the log entry (nonrepudiation) using a public key 353 corresponding to the key used to provide the digital signature. In embodiments, the public key may be provided to multiple processing systems, such as the processors 321, 322, 323. In embodiments, log entries 250, 260, 270 of FIG. 2 may correspond to the log entries 311, 312, and 313 extracted in FIG. 3. In an example, given the seed 00000 shown in FIG. 2 the processing results for each processing unit 321, 322, 323 processing in accordance with 350 using the seed would produce a nonrepudiation set, i.e. a set of three authenticated log entries. FIG. 3B illustrates an example of an extracted tuple.

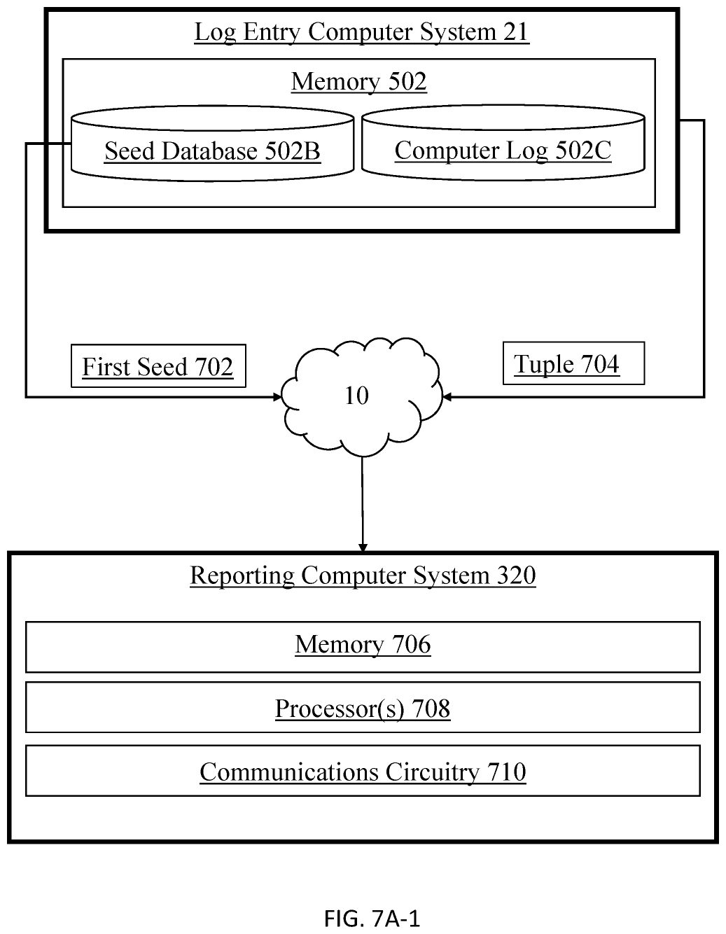

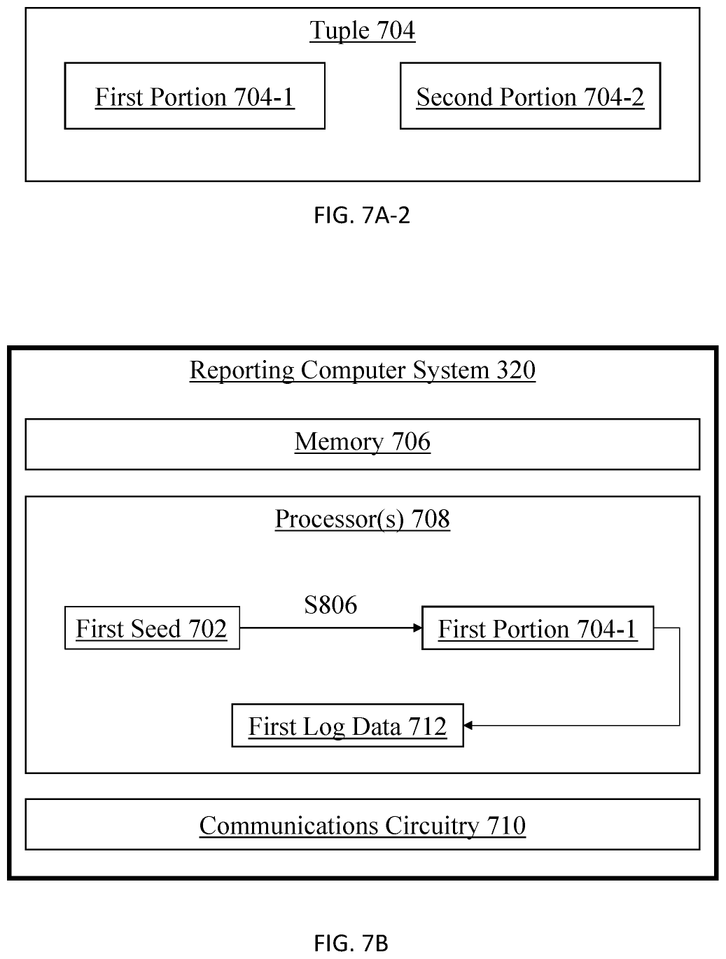

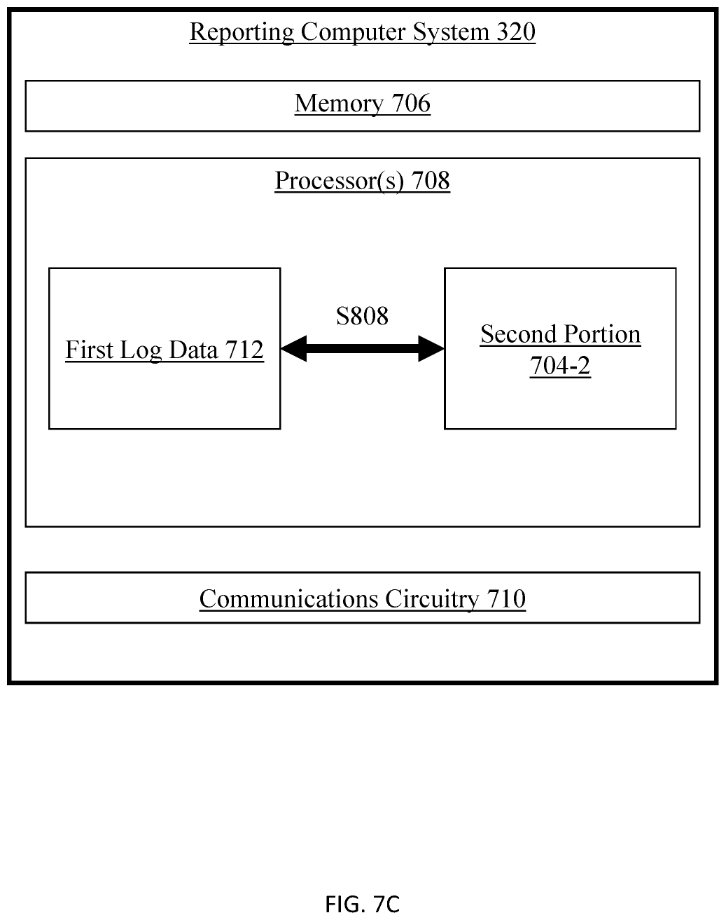

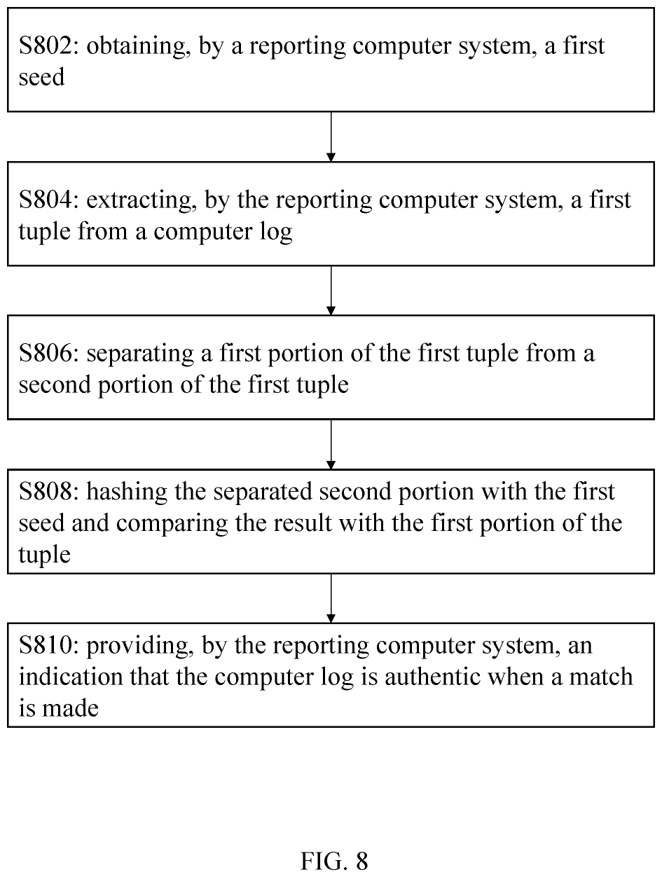

In embodiments, log entries, or tuples 311, may be extracted and authenticated by a reporting computer system 320. In embodiments the extracted tuples 311 are processed, preferably parallel processed as noted above with respect to FIG. 3. In embodiments, the reporting computer system may include one or more processors 708 as can be seen in FIG. 7C, or processors 321, 322, 323 shown in FIG. 3A. The tuples are processed to separate the second element, the log data separated from the first. The public key corresponding to the private key used in the private signature is used to decipher the second portion of the tuple after it is separated. Then the second portion is hashed using the same seed as when logged. The result is then compared to the first part to see if it matches. If there is a match, the tuple is authenticated as the log data has not been modified. The seed used in the reporting computer 320 may be provided from the database 502B of the log entry computer system 21 or seed database 902 as can be seen in FIG. 9A, for example.

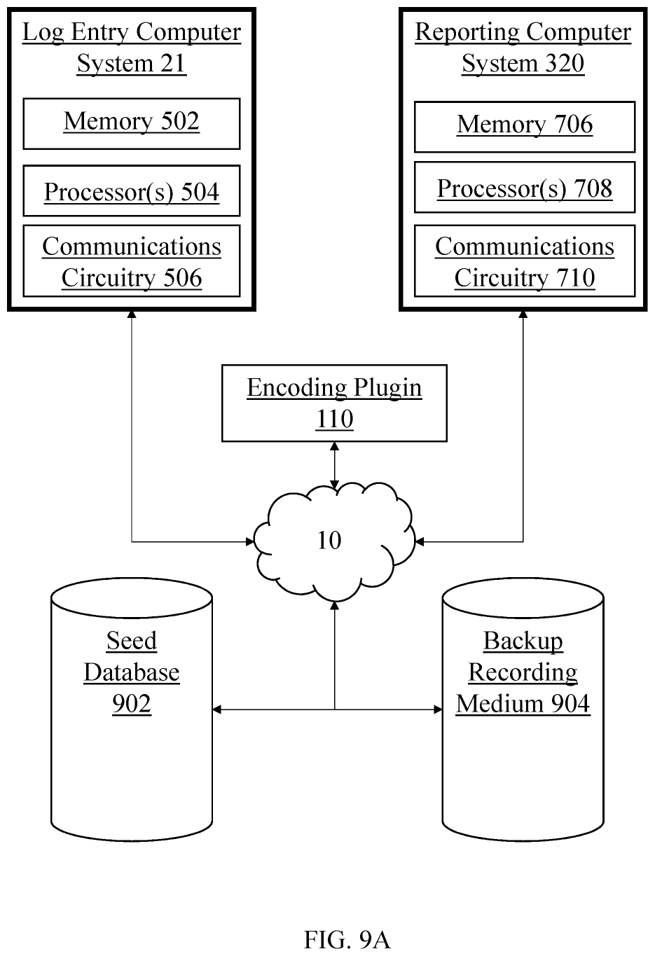

FIG. 8 illustrates an exemplary flow chart of a method of extracting and authenticating individual tuples, or log entries. In embodiments, the steps of FIG. 8 may be implemented by the reporting computer system 320, a reporting application implemented by the log entry computer system 21 or the encoding element 110. At step S802, a first seed may be obtained, by the reporting computer system 320 for example. In embodiments, this see may be the same as the first seed used in FIG. 6. At step S804, at least one log entry is extracted from the computer log by the reporting computer system 320. In embodiments, at step S806 the two portions of the log entry are separated to isolate second portion including the log data. The log data is hashed with the seed and the result is compared to the first portion of the tuple to see if they match at steps S808-S809. If there is a match, the authenticity of the tuple is confirmed and an indication of a match is provided at step S810. If there is no match, this may indicate that the log has been modified and there will be no notice of authenticity. In embodiments, a digital signature associated with the extracted tuple is confirmed base on a public key. In embodiments, the public key is retrieved from a memory or may be received and stored for future use. Confirming the digital signature confirms the log entry has not been tampered with since it was entered with the digital signature. If the signature is not confirmed, this may indicate manipulation of the tuple. In embodiments, an indication of no match or a warning regarding manipulation may be generated and indicated to a user or administrator.

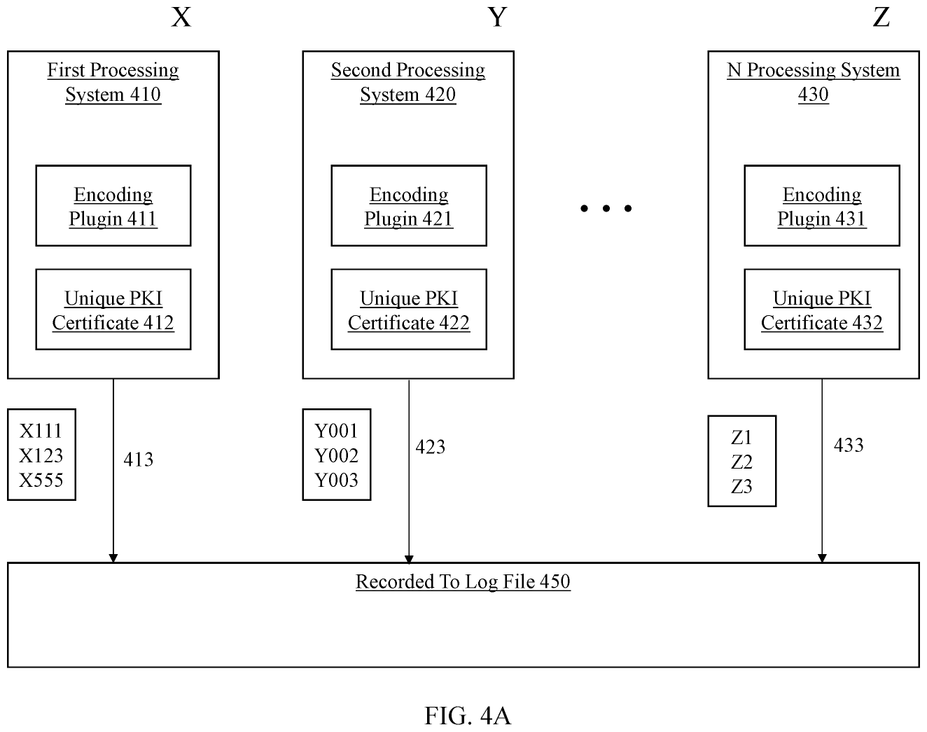

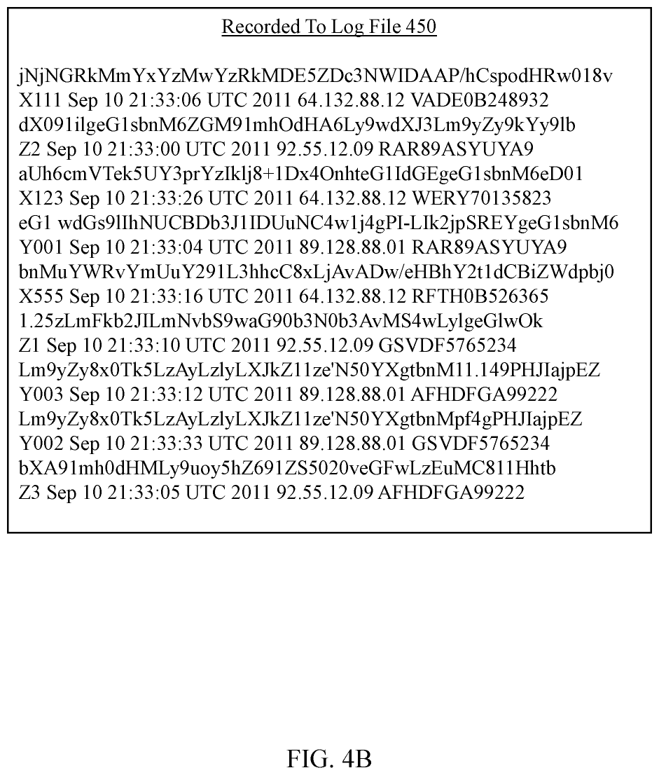

In FIG. 4A, computer systems 410, 420, 430 may be provided to perform transaction processing. In embodiments, a transaction computer system 410 may use an encoding element (or plug-in) 411 (or 110) and a unique public key infrastructure (PKI) to provide a digital signature 412 for the encoding element to use. In embodiments, the encoding element 110 may be or may include or be included in a computer or other processor. In embodiments, the encoding element 411 may be the element 110. In embodiments, the computer system 420 may use the encoding element and a second unique PKI for a digital signature 422, the computer system 430 may use the encoding element or plug-in 431 and a third unique PKI for a digital signature for the encoding plug-in to use. The plug-in may be similar to encoding plug-in 110. In embodiments, three transactions of system 410, indicated by 413, may be recorded to log file 450. In embodiments, the three transactions of system 420, indicated by 423, may be recorded to log file 450. In embodiments, the three transactions of system 430, indicated by 433, may be recorded to log file 450 such that the log file has interlaced log entries in the form of tuples. In embodiments, the log file may include tuples from more than one system. In embodiments, tuples from different systems may use different hash algorithms and different keys. In embodiments, transactions for computer system 410 may be extracted based on the fact that the tuple begins with X and may be authenticated using the known derived seed for the corresponding digital signature of the tuples used by the computer system 410. In embodiments, the identifying feature, such as the X, may be used to determine the hash algorithm and/or key used to create the tuple.

In embodiments, where the encoding member 110 is a part of the log entry computer system 21, as can be seen in FIG. 5B-1 a first seed 512 may be provided to the encoding member which combines it with the log data (log entry 100) with result being hashed and then the hashed result combined with log data to provide the tuple which is recorded in the computer log 140. In embodiments, where the encoding element 110 is provided outside the computer system 21, the seed is transmitted to the element 110 and the tuple is made in a similar manner as can be seen with reference to FIG. 5B-2.

In embodiments, a tuple 311 may be embodied by two separate information sections or elements 311-1, 311, 312 as noted above and illustrated in FIG. 7A-2. In embodiments, the initial, or first element, is a seed and the log information combined and hashed using a modern hash algorithm. In embodiments, this information may then be subsequently signed with a private key corresponding to the private key used to provide the digital signature. In embodiments, the digital signature and the log information may be stored together in a log storage medium such as a log file or database.

In embodiments, the seed used in conjunction with the original log data may be stored with the log information or in a different data storage system as discussed above. In embodiments, the seed may be selected randomly or used to group elements together. In embodiments, any party, or computer system with the seed, or access to the seed, may validate individual tuples in the computer log that belong to the same seed group. In embodiments, parties are thus able to validate individual log entries without the need to store or access or process the entire computer log. In embodiments, the seed may be thought of as a continuous numbering schema to validate belonging elements.

In embodiments, the seed may be a combination of log elements. In embodiments, a calculation using the log elements may be used to generate the seed.

In embodiments, the seed may be used to symmetrically encrypt elements in the log to hide, or disguise, data elements that are of a confidential nature. In embodiments, hashing may take place before or after encryption. In embodiments, hashing may take place after encryption. In this case, even is the party does not have access to the original data, they may authenticate the tuple. In an example, personal identifiable information that is not required to diagnose or work with the log information may be encrypted. In another embodiment, a public key may be used to encrypt all or selective information instead of the symmetric approach. In embodiments, the encrypted information may be made more readable by applying translation in the form of a BASE64, 00 or similar encoding algorithm.

In embodiments, the seed may be generated to group together otherwise non-linkable transactional information. In embodiments, the seed may be based on the user or system involved or other information usable to group together log information or a combination thereof.

In embodiments, the public key may utilize public key infrastructure (PKI). In embodiments, different systems may write into the log, each using its own key pair, with trust in between each other so that the different systems validate the signed first element of the tuple entry

In embodiments, to provide protection from removing log elements, one or more copies of each log element may be stored on a different system, or systems. In embodiments, a full copy of the log maybe stored in alternative storage media.

In embodiments, an encoding element may be used by or included in one or more processing computer systems to enable translation of a log entry to a tuple including a first element in the form of a digital signature derived based on a seed and original log entry data, where the original log entry data is a second element of the tuple and the seed is chosen to collect log entries and enable authentication of the log entries to provide a subset of authenticated entries.

In embodiments, the second element of the tuple may include the seed.

In embodiments, the first element of the tuple may include the seed as log entry data stashed into a database for security to hide aspects of set information for log entries that may be filtered for selection of log entries for authentication.

In embodiments, one or more tuples may be selected from a written log file to authenticate the tuples using the known derived seed for the digital signature of the tuple pairs.

In embodiments, multiple processors may use the encoding plug-in to write log entries as tuples to a log file in any order to allow for high throughput.

In embodiments, the plug-in may write more than one tuple with different seeds creating a symmetric different set.

In embodiments the first element of the tuple may be based on a symmetric-key algorithm encrypted for security of sampling log entries to prevent public key breaking.

In embodiments, the second element of the tuple may be selectively or completely encrypted. In examples encryption may be used to disguise personal information, for example.

In embodiments, the second element of the tuple may be formatted to be readable text such using Base58, for example.

In embodiments, the tuple may be written to the log file using a formal syntax to provide for extraction of information for third party use applications. In embodiments, the syntax may be JSON, XML, Common Log format or Syslog, to name a few.

In embodiments, multiple processing units may be used to authenticate written log entries extracted from a log file as described above.

In embodiments, a public key may be distributed to parties to independently prove authenticity of the tuple in the log file. In embodiments, the public key may be provided to any party that may be uses to authenticate log entries.

In embodiments, public key infrastructure PKI may be used in the first element of the tuple and may be uniquely defined for each processor that hashes and signs the tuple.

An advantage of the present disclosure is that it is easy to prove whether individual log entries have been manipulated, based on the first element of the tuple and the public key which is generated by the private key used for signing each tuple.

In embodiments, it is possible to prove that elements belong together without the complete log. In embodiments, only the correct seed will generate the same hash in the first element of the tuple. In embodiments, even if the same key was not used for signing, but rather a seed that is detectably equal, elements in the log entry may still be proofed.

In embodiments, an audit trail may be provided using the above process and system in which the seed may uniquely and transparently identify the person or entity booking each transaction.

In embodiments, complete removal or deletion of a tuple or element thereof, from the log may be identified or flagged in a variety of ways. In embodiments, deletion of a tuple may be prohibited or prevented. In some embodiments, however, the removal of a tuple may not be a concern. In embodiments, for logs of lesser value, general log rotation may be practiced in which case removal of log entries may be common. In embodiments, in systems that has low risk of data manipulation, entry deletion may be permissible.

In embodiments, a write once, read many database or data storage element, typically referred to as a read only memory (ROM) may be used to store the tuples of the log. In embodiments where a ROM is used, specialized hardware fully secures the data in the ROM. In embodiments, the ROM may be an optical disk, for example. In embodiments, the ROM may be a read only flash drive. In embodiments, use of the ROM essentially makes removal of a tuple impossible, without obviously damaging all the data saved on the ROM.

In embodiments, the storage of each tuple may be duplicated on several storage systems or elements. In embodiments, each tuple may be recorded on multiple memory or storage systems or elements such that malicious deletion of a tuple would require access to each and every storage system or element to completely delete the data. In embodiment, multiple storage systems allow for copies of the log to be maintained, which may be compared to each other to detect unauthorized deletion of information and also provide backup and restore capabilities.

In embodiments, an atomic counter count may be embedded in the second element of the tuple, for example. In embodiments, the count may be hashed and processed with the rest of the input, and hence, become immutable. In embodiments, the count may be queried externally or simply embedded as part of the process and data. In embodiments, the embedded atomic counter may be increased whenever a new element is added. In embodiments, an external counter may be a stand-alone device and may be queried each time a new element is added to the log to provide the count that may be included in the second element of the tuple.

In embodiments, a missing or out of place count in a tuple may be used to detect removal of a tuple or other tampering with the log. In embodiments, the missing counter count may be detected based on a comparison to the current counter status. In embodiments, the missing counter count may be detected based on comparison with another version of the log stored on a separate storage system or element.

In embodiments, a hash of the previous log entry may be stored within the two elements of the tuple. In embodiments, this technique may create a continuous chain of tuple elements, with each prior entry linked to the subsequent entry via the hash of the prior entry. In embodiments, rather than hashing the next and/or previous log entry, one or multiple random elements of the log may be hashed and included in the elements of each tuple. In embodiments, hashing one or more random entries in the elements of the tuple provides for removal detection in a non-obvious way. In such embodiments, in order to validate the tuple, the processor or encryption member that authenticates the tuple must know which of the random entries have been selected.

In embodiments, a Merkle tree may be built with different tuple elements, however, this approach is subject to the limitations of Merkle trees discussed above.

In embodiments, a periodic status of the log may be written to an external system to fix the status of the log at that time. In embodiments, a hash of the entire log may be made, either on a regular schedule, randomly or based on occurrence of a trigger event. In embodiments, the trigger to hash the entire log may be based on a total number of entries, for example. In embodiments, the hash of the entire log may be accompanied by a timestamp and signed with the private key. In embodiments, the time stamped hash and signature may be stored on a different system than the log or data storage system. In embodiments, a check for missing information may be performed by comparing a hash of the current state of the log with the externally stored hash of the prior version of the log.

In embodiments, a delete function may be provided to allow for the proper and authorized removal of tuples from the log. In embodiments, this delete function may vary dependent on which of the deletion prevention or detecting techniques generally discussed above are used. In embodiments, the removal of the tuple itself may be a logged event such that a record is made in the log itself of the change. In embodiments, removal of the tuple may require an electronic signature based on an authorized key. In embodiments, the removal process may require multiple steps.

In embodiments, one or more of the deletion protection or detection techniques discussed above may be used together.

In embodiments the method and system of the present application may be used to securely maintain and authenticate events other than those in computer systems and applications. In embodiments, the method and system of the present application may be used to create and secure records in a variety of applications.

In embodiments, the method and system of the present disclosure may be used to provide authenticity, trust and security to records associated with purchasing and selling goods as well. In embodiments, a participant, or user, may be a person, corporation or other legal entity. Participants may act in the role of buyer or seller. In embodiments, the participants may be custodians or other trusted entities that may be responsible for settlement of financial issues and/or for delivery of goods. In embodiments, each participant may be checked and authenticated or otherwise vetted before being able to participate in the purchasing and selling of goods. In embodiments, participants may be provided on an invite only basis, and may be required to provide digital copies of official papers or similar credentials. In embodiments, other records or credentials may be required and may be checked or validated before transactions are permitted.

In embodiments, log entries indicative of transactions and offers for transactions may be created, stored and authenticated in the manner discussed above. In embodiments, each and every participant may be issued their own certificate associated with a digital key unique to the participant or user that may be used to authorize transactions. In embodiments, different levels of cooperation may be established, and a root certificate may be provided for individual entities and associated with individual users linked or associated with that organization. In embodiments, related certificates may have allowance and other requirements associated therewith as described in further detail below. In embodiments, dual or multiple signatures may be required to finalize transactions and authenticate records thereof.

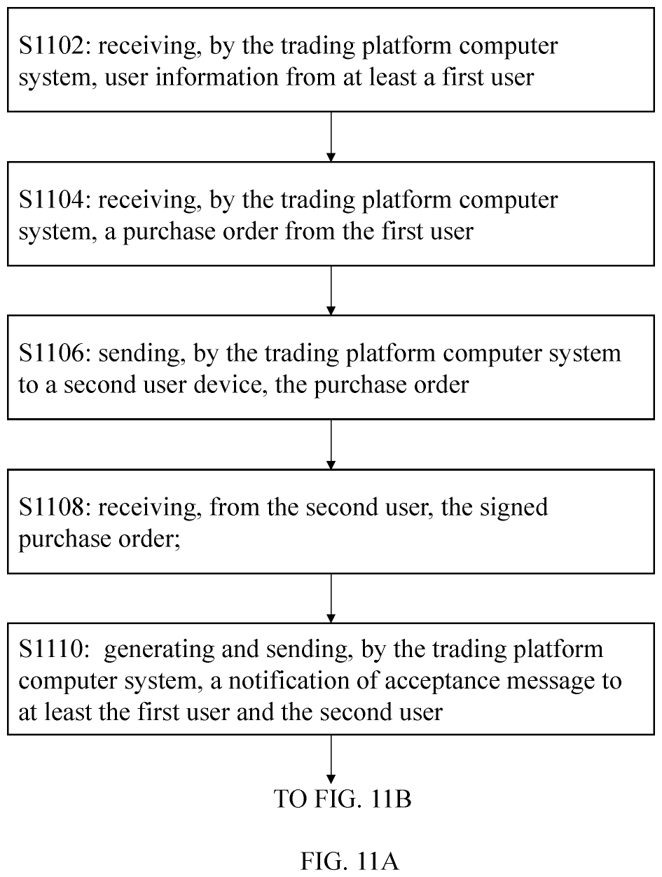

In embodiments, the method and system of the present disclosure may be used to implement a trading platform 1000 (see FIG. 10, for example) in which transactions are logged and recorded in the manner described above. In embodiments, the trading platform 1000 may be implemented using, or may include, one or more computer devices in a computer system that include one or more processors operatively connected to one or more memory elements. In embodiments, the one or more memory elements may include processor executable code that may be executed by the processors to provide for processing and documenting digital transactions. In embodiments, the trading platform 1000 may be accessible via a graphical user interface (GUI), presented on a desktop or mobile computing system, such as a first user device 1002a or a second user device 1002b via a communications network or bus 10, to name few. In embodiments, the communications network 10 may include any electronic communications network, including the Internet, a cellular network, a wireless network (such as WiFi or Bluetooth to name a few) or the like. In embodiments, the GUI may be provided via a website or related technology to provide access via a web browser. In embodiments, the trading platform 1000 may include or provide an Application Programable Interface (API) 1004 for other custom applications to provide a user interface to the trading platform. In embodiments, the API 1004 may be a Representational State Transfer (REST) API, Simple Object Access Protocol (SOAP) API or may use any other suitable API architecture or technology. In embodiments, the trading platform 1000 may connect with one of more APIs provided by other 3^{rd} party applications 1006 for interaction and integration with the trading platform 1000. In embodiments, some interfaces may provide more or less functionality than others. In embodiments, the API 1004 provided by or on behalf of the trading platform 1000 may provide full access, while use of an API provided by a 3^{rd} party application may provide limited access or functionality on the trading platform 1000. In embodiments, direct access to the trading platform 1000 via the Internet using a web browser and graphical user interface on a desktop or mobile computing device 1002a, 1002b or operably connected to the trading platform 1000 may provide for full access and functionality while access via a third-party API may provide more limited access and functionality. In embodiments, full access and functionality may be provided regardless of the interface used to connect with the trading platform 1000.

In embodiments, notifications of sales and purchases may be required to finalize transactions and/or to authenticate or secure records thereof. In embodiments, certificates may be used to sign and validate different event records. In embodiments, such digital signature may provide the trust necessary to confirm sales and purchases with supporting records being easy to authenticate using the secure log techniques discussed above.

In embodiments, every user of the trading platform 1000 may be individually identified and validated. In embodiments, users may be individual people or may be entities such as companies, institutions, communities or other groups. In embodiments, individual users may also belong to, or be associated with, a company, institution, community or other group of people or users. In embodiments, in such cases, there may be internal hierarchies within these entities such that certain activities or actions may require multiple signatures. In embodiments, any legal entity or individual that wants to be a user must be checked and validated. In embodiments, validation may be based on information provided by the user and saved in the one or more memory elements 1001, for example, operably connected to the trading platform 1000. In embodiments, validation requirements may be based on or associated with contractual obligations between the users and an administrator of the trading platform 1000. In embodiments, validation may require a detailed vetting procedure in which information provided by a user may be confirmed by third parties or by the trading platform 1000 or an administrator thereof. In embodiments, government regulation or jurisdictional laws may proscribe the level of vetting necessary to validate users. In embodiments, validating users may be done in advance and user information 1005 related to validated users only may be stored and accessed by the trading platform 1000 in the memory element 1001. The stored user information 1005 may include identifying information uniquely associate with each user which may include user credentials such as a username and password to name a few. In embodiments, the unique information may include a certificate, issued by a certificate authority or other trusted entity, confirming the identity of each user.

In embodiments, each user, whether an individual or entity, once validated may be issued a certificate by the trading platform 1000 as noted above. In embodiments, the certificate may be issued by a third-party certificate authority as is common in PKI systems and stored in a memory 1001 operably connected to the trading platform 1000. In embodiments, a company or entity may serve as their own certificate authority. In embodiments, a company or other entity may have a chain of certificates generated or imported for them In a Public Key Infrastructure (PKI) system, each user or participant is associated with a unique digital key and a trusted certificate authority issues a certificate, digitally signed by the certificate authority, confirming that the unique digital key is uniquely associated with the specific user. In embodiments, as noted above, the trading platform 1000 may make use of a Public Key Infrastructure to validate communications and transactions of every validated user or entity that is authorized to access the trading platform 1000. In embodiments, every user or entity may be issued a unique digital key, which may be authenticated by the certificate issued by the certificate authority. In a PKI system, each user or participant is associated with a unique digital key and a trusted certificate authority issues a certificate, digitally signed by the certificate authority, confirming that the unique digital key is uniquely associated with the specific user. In embodiments, the certificate may be used to provide a unique digital signature associated with the user. In embodiments, certificates may be saved in the memory 1001, for example, with the user information 1005.

In embodiments, whether users directly access the trading platform 1000 or access the trading platform indirectly via the API and another application, they must authenticate or identify themselves. In embodiments, the authentication mechanism used to identify users may use existing services like Active Directory, LDAP, Azure Active directory or FIDO2. In embodiments, multi-factor authentication or other mechanisms may be implemented to identify the user and/or an application being used by the user to access the trading platform. In embodiments, identification may include identification of the application the user implements to access the trading platform 1000 and may be accomplished via other standard mechanisms such as mutual authentication, symmetric keys, Oauth2.0, Oauth and the like. In embodiments, communication between remote users and the trading platform 1000 may be encrypted via TLS and/or another encryption mechanism to provide secure communication between a remote user and the trading platform. In embodiments, other encrypting techniques and protocols may be used to encrypt communication between the remote user and the platform 1000. In embodiments, the trading platform 1000 may also use message level encryption in addition to transport level security to maintain security of communications. In embodiments, once the user or application implemented by the user is authenticated, access to the trading platform 1000 may be provided. In embodiments, access or rights on the trading platform 1000 may be limited or defined based on user identity or the interface being used as noted above.

In embodiments, the trading platform 1000 may allow each user to configure signature authority on a per user basis and may provide for an override based on a third or additional signatures. In an example, an entity may configure layers of authority in accordance with the following structure:

Official certificate of the entity
Entity is allowed up to $6 million in activity
User A is authorized to sign up to $2 million in activity
   Certificate for User A
User B is authorized to sign up to maximum amount of activity
   Certificate for User B
      In the above structure, the “official certificate” may be used to uniquely identify the entity and may be used to validate any transaction of any amount up to the limit associated with the entity ($6 million dollars in this case). User A may be associated with the entity and may be issued their own certificate (User A Certificate) associated with their own unique digital key. As indicated above, the rights or authorization associated with User A may be limited, in this case, to transactions with a value of $2 million or less. That is, User A may authorize transactions that are worth up to $2 million dollars with their digital signature/certificate. In the above structure, User B may also be associated with the entity and is authorized to validate transactions up to the maximum limit associated with the entity ($6 million in this case). In embodiments, the certificate of the executing user (e.g. User A Certificate) may be used to sign and authorize transactions, however, a clear relationship between the official certificate of the entity and the user certificate must be established. In one example, entity A may have several individual users associated therewith, each with their own certificate, including User A and User B, for example discussed above. In embodiments, there will be a common element or attribute shared by all of the certificates associate with the users associated with entity A, such as, they are issued by a common certificate authority. In embodiments, the certificates associated with users associated with a common entity may include another common trait or attribute. In embodiments, all of the users associated with entity A may use the official certificate associated with entity A. In such embodiments, other limitations may be provided to limit the ability of any individual user from engaging in transactions that will max out a transaction limitation associated with the entity. In embodiments, this may be a security feature to prevent malfeasance. In such embodiments, in addition, a clear record of the specific user that engaged in the transaction should be generated and securely stored. In embodiments, where the official certificate is used, a request to use the certificate of User A may be logged as well. In embodiments, the request may require approval by User B. In embodiments, when the trading platform 1000 receives a purchase order signed by a user for which the transaction amount exceeds the transaction limitation associated with the user, a request for authorization may be sent to at least one associated user associated with the same entity to request authorization. The transaction will not proceed unless the purchase order is signed using the certificate of the associated user with sufficient authority or a new purchase order signed by that authorized associated user is received by the trading platform. The request for the additional signature may be generated and sent by the Trading platform 1000. In embodiments, even where a transaction amount is below a limit associated with a particular user, there may be occasions where additional signatures are requested and required to complete a transactions. In embodiments, limitations associated with each user may be based on transaction type, transaction amount or other parameters, such as limitations based on time. In embodiments, transactions involving certain products may require additional signatures. In embodiments, where a user exceeds a certain number of transactions performed over a period of time, there may be a requirement for another signature. In embodiments, a total value of transactions that occur over a period of time may trigger a requirement for another signature/certificate even if each individual transaction is under the limit associated with the user.

In embodiments, each purchase/transaction to be performed by the transaction platform 1000 may be assigned a new product purchase identification or purchasing ID by the Trading Platform 1000. In embodiments, the purchasing ID may be similar to information used in existing identification systems to keep compatibility with systems in use today or may be randomly generated and may contain further information. In embodiments, the purchasing ID may be a physical ID found on the product that is being sold. In embodiments, the purchasing ID may be used as the seed used in the secure log that will store all transaction information. That is, in embodiments, the purchasing ID may be used as the seed in the tuple used to record the purchase/transaction in a record of a secure log that is provided in the manner described above. In embodiments, the tuples stored in the secure log may be recorded in memory 1001. In embodiments, the tuples stored in the secure log may be stored in other memory elements to provide additional security and redundancy. In embodiments, the tuple stored in the secure log may be extracted and authenticated in the manner discussed above. Using the purchasing ID as the seed will allow for easy authentication of records and ensure that all records related to the same transaction can be immutably stored.

In embodiments, a purchaser's name, desired product, quantity, price, purchasing ID and other information to identify a purchase/transaction may be provided to the seller of the desired product, by the trading platform 1000, for example. In embodiments, the purchaser may simply be a first user of the trading platform. In embodiments, the first user will generate and send a purchase order to the trading platform 1000 using a first user computer device 1002a, which may be a personal computer, laptop, mobile computer or other mobile electronic device, to name a few. The format of the purchase order may be designated by the API, for example, or may be provided via a third-party API. In embodiments, the purchase order may include the purchaser's signature based on their certificate. In embodiments, the input to the signature may be the data being transmitted (the log data reflecting the purchase order) plus the seed, which may be the purchasing ID provided by the trading platform 1000, to form a tuple as discussed above to be stored in a secure log by the trading platform. In embodiments, the trading platform 1000 may include or be operably connected to the encoding member 110 which may be provided the seed as well as transaction information to provide a tuple to be stored in the secure log in the manner described above. In embodiments, when the digital signature is added, the seed may be added and signed and countersign information may be stored in the computer log (which may be referred to as a transaction log) to make a record of all aspects of the transaction in a secure and immutable manner. In embodiments, the trading platform 1000 may create and record a tuple for a log entry reflecting the purchase, or purchase order, and/or may simply save the information in the memory 1001, for example. The purchase order may be sent by the trading platform 1000 to the seller. The log entry may be in the form of a tuple formatted as discussed above. In embodiments, it may be accompanied by an e-mail notification or the like to one or many participants on the seller side of the transaction.

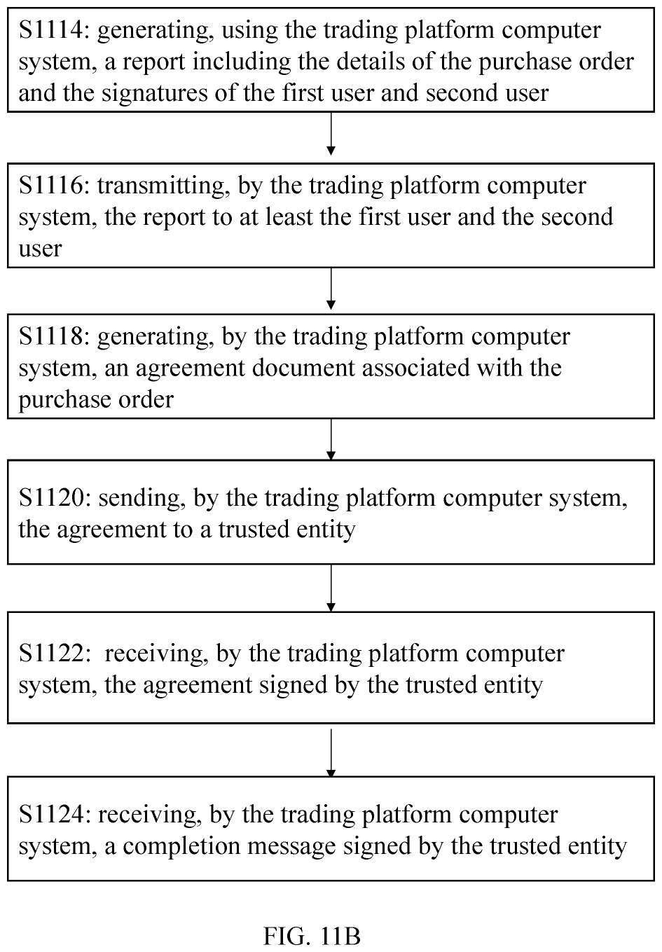

In embodiments, the trading platform 1000 may allow users (producers/traders) to sell their goods and other users (buyers/purchasers) to purchase the goods. In embodiments, users that buy goods may resell them to their own customers, if desired. In embodiments, a process of buying and selling may be executed as indicated in FIGS. 11A-11B. In embodiments, at step S1102 a user (a first user) may be identified and log into the trading platform computer system 1000, for example. During this process, the user may send identification information to the trading platform computer system 1000 where it is received and compared to validated user information stored in memory 1001, for example to identify the first user. In embodiments, the user will use a first user device, such as a personal computer, laptop or mobile electronic device, to name a few, to provide the identification information. The user may be identified and authorized access to the trading platform 1000 based the identification information submitted. In embodiments, identification may be accomplished using the user's certificate. In embodiments, this authentication step may be accomplished by submission of credentials (a username and password, for example) that may be matched to user credentials included in the user information stored in the platform or memory element 1001 operably connected thereto. In embodiments, during this step, the user may be prompted to enter their credential information via the GUI for example, that is provided on a first user device 1002a, for example, associated with the first user. In embodiments, the credential information may be used to access the user certificate associated with the user that may be stored in the memory 1001 with the user information associated with the user included in or operably connected to the trading platform 1000.

In embodiments, at step S1104, once authenticated, a user, such as the first user may submit a purchase order that is received by the trading platform 1000 from the first user device 1002a, for example, associated with the first user. In embodiments, the purchase order may identify the product or products to be purchased, a quantity, a price and may include a digital signature provided based on the certificate associated with the purchasing user, the first user. In embodiments, a sub-step may include determining whether the price is above an authorization limitation associated with the purchasing user (User A, for example). If so, a notification or request for approval may be generated and provided to an associated user (a second user, User B, for example), or more specifically to a second user device associated with the associated user. In embodiments, the associated user may have a higher authorization limit than the first user. In embodiments, upon receipt of the associated user's signature based on their certificate, which may be sent by the second user device 1002b, for example, to the trading platform 1000 and assuming that the associated user has sufficient authority, if necessary, the purchase order and all signatures may be stored with the purchasing ID in the memory 1001. In embodiments, this information may be stored in the secure log in the manner discussed above as a tuple. In such a case, as noted above, the purchasing ID may be used as a seed to generate the tuple for the secure log in which the information is stored, as discussed above. In embodiments, this information will always be used whenever a signature is being applied in the process of FIGS. 11A-11B. In embodiments, the step S1104 may also include a sub-step of validating the signature of the purchasing user (the first user), for example, based on the associated first user certificate. In embodiments, the official certificate may be used to sign the purchase order and the signed purchase order may be stored in the log of transactions. In embodiments, where the purchaser signature is associated with sufficient authority to complete the transaction, no further signatures may be necessary.

In embodiments, at step S1106, a seller (a second user) may receive the signed purchase order from the trading platform 1000. The purchase order sent to the seller may include the purchasing ID associated with the transaction and may be provided by the trading platform 1000. At step 1108, the seller (second user) may accept the purchase order by countersigning it using their own certificate. In embodiments, the accepting step S1108 may include or be preceded by a sub-step in which the signature(s) of the purchaser (first user) and any other requested signatures may be validated. This may be done by confirming the certificate of the purchaser (and any other signers) either independently or via a certificate authority and may be done by the trading platform 1000 of by the second user device 1002b. After acceptance by the seller, the countersigned purchase order may be sent by the seller device (second user device 1002b, for example) to the trading platform 1000. After receiving the countersigned purchase order, the trading platform 1000 may generate a notification of acceptance and send it to all necessary parties to the transaction at step S1110, including the trading platform 1000. In embodiments, the confirmation may be sent to the trading platform 1000, and the trading platform may distribute it to all necessary parties. The necessary parties may include the purchaser, seller and any other parties whose digital signature is included in either the purchase order or the acceptance. In embodiments, in the event that the purchase order is not accepted and the seller does not countersign the purchase order, a notification of non-acceptance may be generated and sent to all relevant parties. In embodiments, both notifications, may be sent via SMS, E-mail or other means by the trading platform 1000, for example. In embodiments, the seller may not countersign or add any additional information to the purchase order and notification of nonacceptance may be sent as noted above. In embodiments, the counter-signed purchase order may be recorded in the secure log or other records repository in the secure manner described above by the trading platform 1000 and/or may be sent back to the purchaser and/or the trading platform 1000. In embodiments, integration into another business application and generation of specific legal documents that are signed by the certificates may be necessary in certain transaction involving certain user but not in others. For example, for gas trading transaction in Europe, these actions are required, however, not for other transactions.

In embodiments, in step S1114, a report may be generated by the trading platform 1000 including the purchase order details and including the signatures of the purchaser and seller based on their respective certificates. In embodiment, the report may be stored in the secure log in the secure manner described above, for example as a tuple. As noted above, the purchasing ID may be used as a seed to provide the tuple to be added to the secure log in the manner described above. The second part of the tuple may include the signed and countersigned purchase order, confirmation and signatures of the purchaser and buyer. In embodiments, where the transaction relates to energy, the report may be a Regulation on Wholesale Energy Market Integrity and Transparency (REMIT) report. Under REMIT, participants are required to report wholesale energy market contracts within the EU to the Agency for Cooperation of Energy Regulators (ACER). In embodiments, the report, including the REMIT report may be stored in the log in the secure manner described above. In step S1116, the report may be sent electronically to a recipient. In embodiments, where the report is a REMIT report, it may be sent electronically to ACER. Since the report includes the signatures of the participants (first user and second user) based on their certificates, it can be easily validated by appropriate authorities. In the event of a problem or a lack of validation, notification may be sent to the trading platform 1000, for example. In embodiments, the report may be stored by the trading platform 1000, in the secure log in the manner described above as a tuple. In embodiments, where the transaction is associated with an energy contract, a Frame Transport Agreement may be generated at the trading platform 1000 and include the signatures of the purchaser and seller. Otherwise, where the transaction is not energy related, the trading platform 1000 may generate a purchase agreement or other documentation to evidence the transaction at step S1118. This documentation may include the signatures of the purchaser and seller or may be transmitted to the purchaser and seller by the trading platform 1000 such that the purchaser and seller may sign it and return it to the trading platform. In embodiments, the signed document may be returned to the trading platform 1000. In embodiments, the trading platform 1000 may send the agreement or other documentation, including the Frame Transport Agreement to a grid operator, where energy is involved, or to another trusted entity or custodian that may be used to settle the transaction at step S1120 In embodiments, settlement may include delivering or authorizing delivery of funds to the seller and/or transferring or authorizing transfer of the product to the purchaser. In embodiments, in step S1122, when the grid operator or other trusted entity or custodian is a user (third user 1002c, for example) of the trading platform 1000, they may countersign the Frame Transport Agreement or other documentation using their certificate and return it to the trading platform 1000. In embodiments, the grid operator or other trusted entity or custodian may also generate a completion message and sign it using their certificate in the step S1124 and send it to the trading platform 1000 confirming completion of the transaction. The signed agreement and/or the signed completion confirmation may be recorded in the secure log in the manner described above.

In embodiments, the buyer (first user) may sign a buyer confirmation completion message using their certificate to confirm that the product has been delivered. In embodiments, the seller (second user) may provide a seller confirmation after payment is received. In embodiments, payment may be made by wire transfer, ACH, or otherwise and the seller may send the delivery message and sign it to confirm that payment has been received.

In embodiments, all messages between the users, trusted entities and the trading platform 1000 may include the product purchase identification (purchasing ID) which may be used as the seed for creating the tuple that may be used to store all of the communications in the secure log in the manner described above such that all communications may be stored in the secure log in a secure and verifiable manner. In embodiments, other information may be used as the seed provided that the same information is used for all communications to confirm that all communications apply to the same transaction for all parties interested. In different embodiments, the custodian or trusted entity may confirm that money is available, prior to the seller accepting the purchase order. In embodiments, the custodian may transfer payment to the corresponding party and send a payment notification to be recorded in the secure log, or otherwise, by the platform 1000. In embodiments, both parties (purchaser and seller) may counter-sign this as well. In embodiments, all communications regarding transactions may be recorded by the platform 1000 using the system described above in the secure log and/or in another repository. In embodiments, collaboration with other 3^{rd} party systems may be desired or legally appropriate. In embodiments, reports may be generated based on the records, for example for the custodian or regulators. In embodiments, these records may be combined with the seed, hashed and stored in the manner discussed above in the secure log. In embodiments, including the seed makes clear that the records belong to the same transaction.

In embodiments, all communications may be signed and recorded on a storage medium operably connected to the trading platform 1000, in different embodiments potentially different mediums may be used. In embodiments, distributed databases, database replication or other storage media may be used to store records of all of these interactions and/or the secure computer log.

In embodiments, the money transfer may also be processed using the trading platform 1000. In embodiments, a trusted entity such as a custodian may maintain funds on behalf of one or both sides of the transaction (purchaser and seller). In embodiments, the custodian may be a user associated with a third user device 1002c of the platform 1000 and may provide a signature to confirm that the money is available and will be wired to the seller on time, by copying the money value from the purchase order, for example and signing using their own certificate. This confirmation may be sent to the trading platform 1000 and then sent to the seller. In embodiments, as noted above, this confirmation may be provided in the form of the purchase order being signed by the custodian using their certificate. This may take place before the seller accepts the purchase order. In embodiments, the trading platform 1000 may store this information within the secure log as part of the transaction record. In embodiments, the trading platform 1000 may be operatively connected to one or more bank or other financial institution computer system and configured to receive financial information related to one or more users of the system. In embodiments, the trading platform 1000 may store account information associated with each user in the user information 1005, for example, in one or more memory operatively connected thereto and the trading platform 1000 may provide confirmation of available funds itself. In embodiments, a particular bank or financial institution may be selected and the trading platform 1000 may establish a contractual relationship therewith to hold user funds for the purpose of trading on the trading platform 1000. In embodiments, validated users may establish accounts in the selected bank or financial institution. In embodiments, the bank or financial institution may be a user of the trading platform 1000 and may have its own certificate and digital key. In embodiments, the bank or financial institution may sign the purchase order using their certificate to confirm that the purchaser has sufficient funds to complete the purchase. In embodiments, the bank or financial institution may also provide a notification to all parties via the trading platform 1000 indicating when funds will be transferred which may also be signed using the bank or financial institution using their certificate. In embodiments, therefor the bank of financial institution assumes the role of custodian. Where the purchaser and seller establish accounts in the same bank or financial institution, payments may be made by the bank or financial institution acting as custodian by simple ledger entry. In embodiments, the trading platform 1000, or an administrator thereof, may assume the role of custodian and provide instructions to the bank or financial institution to make payments from the user accounts.

In embodiments, the trading platform 1000 may generate a bill and send it to all participants in the transaction, including purchaser, seller and the bank or financial institution or other custodian such that all parties are made aware of the funds expected and to be paid.

In embodiments, the architecture of the trading platform 1000 may include the authentication layer, the business logic and finally the data storage for all requests, information and certificates. The data storage layer may include a secure log such as that described above in which transaction records, including all messages between the parties are recorded in a secure manner using the tuple format described above herein.

In embodiments, the storage of the records and the information, including the tuples recorded in the secure log may be made in a normal database or distributed database for additional scalability and security. In embodiments, the purchasing ID may be used as the seed, however, the seed may be generated based on existing market conventions or generated based on a purchaser ID and seller ID or other combinations and rules that allow the transaction to be clearly identified.

Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly.

What is claimed is:

1. A method for processing and documenting a digital transaction comprises:
(a) receiving, at the trading platform computer system, identification information from at least a first user device associated with a first user;
(b) identifying, by the trading platform computer system, the first user based on the identification information;
(c) receiving, by the trading platform computer system, purchase order information from the first user device including a digital signature based on a first user certificate associated with the first user;
(d) sending, by the trading platform computer system to at least one second user device associated with a second user, the purchase order including a purchase identification number associated with the purchased order;
(e) receiving, by the trading platform computer system, a confirmation of the purchase order from the second user device, the confirmation including a second digital signature based on the certificate associated with the second user;
(f) generating, by the trading platform computer system, a second confirmation message indicating acceptance of the purchase order by the second user including the signatures of the first user and the second user;
(g) sending, by the trading platform computer system to at least the first user device and the second user device, the second confirmation message;
(h) generating, by the trading platform computer system, a report including the purchase order, the confirmation message, the purchase identification number and the signatures of the first user and the second user; and
(i) recording, by the trading platform computer system, the report in a secure log.

2. The method of claim 1, wherein the identification information includes user credential associated with the first user.

3. The method of claim 1, wherein the identification information includes a username and a password associated with the first user.

4. The method of claims 1, wherein the identifying step includes a step of accessing, by the trading platform computer system, user information associated with a plurality of validated users and comparing the identification information to the user information to identify the first user.

5. The method of claim 1, wherein the purchase order information includes product information, quantity information and price information.

6. The method of claim 1, wherein the receiving step (c) includes a step of validating the digital signature of the first user.

7. The method of claim 1, wherein the receiving step (c) includes a steps of:
(j) determining whether the purchase order complies with limitations associated with the first user; and
in the case where the purchase order does not comply, sending a request for authorization to at least one associated user.

8. The method of claim 7, further comprising receiving a second purchase order signed by the at least one other user using a certificate associated with the at least one associated user.

9. The method of claim 1, wherein the sending step (d) includes generating a purchase identification number uniquely associated with the purchase order and adding it to the purchase order sent to the second user.

10. The method of claim 9, wherein the purchase identification number is based on the type of product associated with the product information.

11. The method of claim 9, wherein the purchase identification number is used as a seed to provide a tuple to be stored in the secure log operatively connected to the trading platform computer system.

12. The method of claim 1, further comprising:
(j) sending, by the trading platform computer system, the purchase order to a third user device associated with a third user, where the third user is a trusted entity with authority to release funds; and
(k) receiving, by the trading platform computer system from the third user device, a funds confirmation message including a signature of the third user based on the certificate of the third user confirming there are sufficient funds to complete the purchase.

13. The method of claim 12, wherein the sending step (j) and the receiving step (k) are performed before step (e).

14. The method of claim 1, further comprising:
(j) receiving, by the trading platform computer system, a purchase confirmation signed by the first user and confirming receipt of the product.

15. The method of claim 14, further comprising:
(k) receiving, by the trading platform computer system, a seller confirmation signed by the second user confirming receipt of the price of the product.

16. The method of claim 15, further comprising:
(l) storing, by the trading platform computer system, the purchase confirmation and the seller confirmation in the secure log.

17. The method of claim 1 further comprising:
(j) sending, by the trading platform computer system, the report to a regulatory authority.

18. The method of claim 1, wherein the recording step further comprises:
generating, by the trading platform computer system, a tuple based on the report, where a purchase identification number is used as a seed and the additional information is used as a second part of the tuple; and
storing the tuple in the secure log.

19. The method of claim 1, wherein the secure log may be a computer log associated with the trading platform computer system and may include log information associated with each event associated with the trading platform computer system.

20. The method of claim 1, further comprising:
(j) generating, by the trading platform computer system, an agreement document indicative of a transaction associated with the purchase order;
(k) sending, by the trading platform computer system to at least the first user device and the second user device, the agreement document;
(l) receiving, by the trading platform computer system, the agreement document including the first user signature and the second user signature; and
(m) storing, by the trading platform computer system, the agreement document in the secure log.

21. The method of claim 1 further comprising:
(j) transmitting, by the trading platform computer system, the report to a regulatory authority.
